(19) United States
(12) Patent Application Publication
(10) Pub. No.: US 2009/0147179 A1
(43) Pub. Date: Jun. 11, 2009

(54) Prism Sheet and Production Method thereof and Surface Light Source Device

(76) Inventors: Tomoyoshi Yamashita, Kanagawa (JP); Yoshiaki Murayama, Kanagawa (JP); Haruko Ootsuki, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 12/083,672

(22) PCT Filed: Oct. 16, 2006
(86) PCT No.: PCT/JP2006/320579

§ 371 Date: Apr. 16, 2008

(30) Foreign Application Priority Data
Oct. 17, 2005 (JP) 2005-301631
Feb. 3, 2006 (JP) 2006-026877

(51) Int. Cl. G02F 1/1335; G02B 5/04; B29D 11/00; F21V 8/00

(52) U.S. Cl. 349/64; 362/339; 264/1.1; 362/606

(57) ABSTRACT

A prism sheet provided with an elongated prism formed surface (41) on which a plurality of elongated prisms (411) extend in parallel to each other. The elongated prism formed surface (41) has roughened portions (412) each having a width W 0.04 to 0.5 times the arranging pitch P of the elongated prisms and arranged between adjacent elongated prisms (411). The surface of the roughened portion (412) has a center-line average roughness Ra of 0.3-2 μm and a ten-point average roughness Rz of 1-3 μm, and the prism surface (411a, 411b) of elongated prism has a center-line average roughness Ra of less than 0.3 μm and a ten-point average roughness Rz of less than 1 μm.

### TECHNICAL FIELD

The present invention relates to a prism sheet suitable for constituting a surface light source device capable of being used as a backlight of a liquid crystal display device and a production method of the prism sheet. Further, the present invention relates to a surface light source device using the prism sheet.

### BACKGROUND ART

A liquid crystal display device basically comprises a backlight and a liquid crystal display element. As the backlight, an edge light system has been frequently used from a viewpoint of miniaturization of the liquid crystal display device. The backlight of an edge-light type has been heretofore broadly used in which at least one end face of a rectangular plate-shaped light guide is used as a light incident end face, a linear or rod-like primary light source such as a straight tube type florescence lamp is disposed along the light incident end face, and the light emitted from the primary light source is introduced into the light guide from the light incident end face of the light guide and emitted from a light exit face that is one of two major surfaces of the light guide.

In such a backlight, a light deflection element is used in order to deflect the light diagonally emitted from the light exit face of the light guide toward the normal line of the light exit face of light guide in a plane perpendicular to both the light incident end face and light exit face of the light guide. The light deflection element is typically a prism sheet. The prism sheet has one surface which is a smooth surface and the other surface which is an elongated prism formed surface. On the elongated prism formed surface, a plurality of elongated prisms are arranged at a predetermined pitch in parallel to each other.

In order for a liquid crystal display device to meet a demand for high definition display of images, the surface light source device is required to have characteristics of high luminance and of less visibility of a surface structure, such as a mat structure or elongated lens arrangement structure which are formed on the light exit face of the light guide or back surface of the light emitting surface for achieving a required optical function.

For achieving high luminance, the elongated prism formed surface of the prism sheet of the surface light source device can be disposed opposite to the light guide (that is, the elongated prism formed surface can be used as a light entrance surface that receives the light emitted from the light exit face of light guide). However, when a typical prism sheet such as one having a light exit surface (opposite surface to the light entrance surface) formed as a smoothed flat surface is used, the surface structure of the light guide may be made visible in some cases. In order to cope with this problem, as disclosed in JP-06-324205-A (Patent Document 1) and JP-07-151909-A (Patent Document 2), a technique of imparting a fine irregular shape to the surface of the prism sheet opposite to the elongated prism formed surface is applied so as to make it difficult for the surface structure of the light guide to be made visible while maintaining high luminance. Further, JP-09-184906-A (Patent Document 3) discloses a technique for achieving the same purpose by roughening the prism surface.

The surface light source device for a liquid crystal display device is further required to have characteristics of less occurrence of sticking to the liquid crystal display element. JP-2000-353413-A (Patent Document 4) discloses a technique in which a light diffusion sheet is disposed between a liquid crystal display element and prism sheet of the surface light source device. When the light diffusion sheet having a rough surface having fine irregularity is used, the occurrence of sticking between the liquid crystal element and prism sheet can be prevented.

Patent Document 1: JP-06-324205-A

Patent Document 2: JP-07-151909-A

Patent Document 3: JP-09-184906-A

Patent Document 4: JP-2000-353413-A

### DISCLOSURE OF THE INVENTION

### Problems to be Solved by the Invention

However, when the light diffusion sheet is disposed between a liquid crystal display element and prism sheet of the surface light source device as disclosed in Patent Document 3, the number of components of the surface light source device is increased to complicate the assembly operation thereof, leading to an increase in cost. Further, in recent years, along with a demand for simplification of the structure of the surface light source device and reduction in the width and weight thereof, use of the diffusion sheet which is a separate member from the prism sheet has been avoided.

In order to exhibit high luminance and make the light guide surface structure less visible while reducing the number of components of the surface light source device, a technique in which the light diffusion sheet is not used but a fine irregular shape is imparted to the light exit surface of the prism sheet can be considered. To achieve such a purpose, the surface of the light exit surface of the prism sheet needs to be roughened. However, in this case, speckle occurs to deteriorate quality of the surface light source device.

On the other hand, the surface light source device has a problem that a luminance unevenness attributed to the prism sheet becomes easily be made visible as a high-luminance light source is used as a primary light source. More specifically, when there is any cutting mark or defect caused due to plating fault on a metallic mold for producing the prism sheet, the prism sheet is accordingly poorly formed, causing the luminance unevenness to be made visible in some cases. Further, if adhesives of an adhesive protecting sheet to be secured to protect the elongated prism formed surface after the production of the prism sheet remains at, e.g., apex portions of the elongated prisms after the adhesive protecting sheet is peeled off in the production stage of the surface light source device, the luminance unevenness is made visible due to the residual adhesives.

It is desirable to conceal optical defects such as easy visibility of the surface structure of the light guide and luminance unevenness attributed to the prism sheet without use of the light diffusion sheet, without causing sticking between the liquid crystal display element and prism sheet, and without generating speckle.

The present invention has been made in view of the above technical problems, and an object of the present invention is to provide a prism sheet capable of concealing the optical defects while suppressing a reduction of luminance without incurring an increase in cost.

Another object of the present invention is to provide a prism sheet capable of concealing the optical defects without using the light diffusion sheet and without or while reducing occurrence of speckle.

Still another object of the present invention is to provide a surface light source device using the prism sheet mentioned above.

### Means for Solving the Problems

In order to solve the above problems, according to the present invention, there is provided a prism sheet comprising:

an elongated prism formed surface having a plurality of elongated prisms extending in parallel to each other; and

a roughened surface portion extending between adjacent elongated prisms along the elongated prisms,

wherein the roughened surface portion has a larger roughening degree than that of the surface of each elongated prism.

In one aspect of the present invention, the roughened surface portion has a width 0.04 to 0.5 times the arrangement pitch of the elongated prisms. In one aspect of the present invention, the roughening degree of the roughened surface portion is 0.3 to 2 μm in terms of center-line average roughness Ra and 1 to 3 μm in terms of ten-point average roughness Rz. In one aspect of the present invention, the roughening degree of the prism surface of the elongated prism is less than 0.3 μm in terms of center-line average roughness Ra and less than 1 μm in terms of ten-point average roughness Rz. In one aspect of the present invention, the prism sheet is constituted by a transparent substrate whose both surfaces are smooth and a prism portion bonded to one surface of the transparent substrate, and the surface of the prism portion on the side opposite to the surface bonded to the transparent substrate is the elongated prism formed surface.

Further, in order to solve the above problems, according to the present invention, there is provided a method for producing the above prism sheet, comprising:

producing a molding member having a shape transfer surface including a first region having a shape corresponding to or substantially corresponding to the elongated prisms and a second region having a shape substantially corresponding to the roughened surface portion;

applying blasting treatment to the shape transfer surface of the molding member to roughen the second region and make the shape of the second region corresponding to the roughened surface portion; and

forming the elongated prisms on the surface of a synthetic resin sheet using the molding member.

In one aspect of the present invention, the blasting treatment is performed by spraying blasting particles having an average particle diameter 0.3 to 5 times the arrangement pitch of the elongated prisms.

In one aspect of the present invention, the application of the blasting treatment also roughens the first region and makes the shape of the first region corresponding to the elongated prisms. In one aspect of the present invention, the blasting treatment is performed by spraying blasting particles having an average particle diameter 0.3 to 5 times the arrangement pitch of the elongated prisms, and further spraying blasting particles having an average particle diameter 0.1 to 0.5 times the arrangement pitch of the elongated prisms.

In one aspect of the present invention, molding for the surface of the synthetic resin sheet is performed by injecting an active energy ray-curable resin composition between the shape transfer surface of the molding member and transparent substrate whose both surfaces are smooth, and irradiating the active energy ray-curable resin composition with an active energy ray via the transparent substrate to cure the active energy ray-curable resin composition, whereby the prism portion formed of the active energy ray-curable resin and having the elongated prism formed surface is obtained.

Further, in order to solve the above problems, according to the present invention, there is provided a surface light source device comprising:

a primary light source;

a light guide into which light emitted from the primary light source is introduced, by which the introduced light is guided, and from which the guided light is emitted; and

the prism sheet according to claim 1 so disposed as to receive the light emitted from the light guide,

wherein the light guide includes a light incident end face on which the light emitted from the primary light source is incident and a light exit face from which the guided light is emitted, the primary light source is arranged adjacent to the light incident end face of the light guide, and the prism sheet is arranged such that the elongated prism formed surface faces the light exit face of the light guide.

In one aspect of the present invention, the prism sheet is arranged such that the extending direction of the elongated prisms is substantially parallel to the light incident end face of the light guide.

Further, in order to solve the above problems, according to the present invention, there is provided a prism sheet comprising:

an elongated prism formed surface having a plurality of elongated prisms extending in parallel to each other; and

a valley portion extending between adjacent elongated prisms along the elongated prisms,

wherein the valley portion has an irregular cross-sectional shape.

In one aspect of the present invention, the other surface of the prism sheet on the opposite side to the surface which is the elongated prism formed surface has a concavo-convex structure having an average slant angle of 0.2 to 3 degrees, a concavo-convex structure having an arithmetic average roughness Ra of 0.01 μm to 0.05 μm, a concavo-convex structure having a roughness curve maximum valley depth Ry of 0.1 μm to 0.5 μm, a concavo-convex structure having a roughness curve ten-point average roughness Rz of 0.1 μm to 0.5 μm, a concavo-convex structure having a roughness curve element average length Sm of 50 μm to 900 μm, or a concavo-convex structure having a roughness curved surface arithmetic average slant RΔa of 0.1 degrees to 1 degree.

In one aspect of the present invention, the other surface of the prism sheet on the opposite side to the surface which is the elongated prism formed surface has a concavo-convex structure constituted by concavo-convex portions discretely distributed. In one aspect of the present invention, each concavo-convex portion has an outer diameter of 10 μm to 60 μm and a height or depth of 2 μm to 10 μm, and the concavo-convex portions have a distribution density of 5/mm² to 50/mm².

Further, in order to solve the above problems, according to the present invention, there is provided a prism sheet comprising:

a first elongated prism formed surface having a plurality of first elongated prisms extending in parallel to each other;

a second elongated prism formed surface having a plurality of second elongated prisms extending in parallel to each other; and

a first valley portion extending between adjacent first elongated prisms along the first elongated prisms,

wherein the first valley portion has an irregular cross-sectional shape.

In one aspect of the present invention, the prism sheet further comprises a second valley portion extending between adjacent second elongated prisms along the second elongated prisms, wherein the second valley portion has an irregular cross-sectional shape. In one aspect of the present invention, the second elongated prisms extend perpendicular to the first elongated prisms.

In one aspect of the present invention, the elongated prisms or at least one of the first and second elongated prisms are concentrically arranged.

Further, in order to solve the above problems, according to the present invention, there is provided a surface light source device comprising:

a primary light source;

a light guide into which light emitted from the primary light source is introduced, by which the introduced light is guided, and from which the guided light is emitted; and

the above prism sheet so disposed as to receive the light emitted from the light guide,

wherein the light guide includes a light incident end face on which the light emitted from the primary light source is incident and a light exit face from which the guided light is emitted, the primary light source is arranged adjacent to the light incident end face of the light guide, and the prism sheet is arranged such that the elongated prism formed surface or the first or second elongated prism formed surface faces the light exit face of the light guide.

Further, according to the present invention, there is provided a liquid crystal display device comprising:

the above surface light source device; and

a liquid crystal display element,

wherein the surface light source device includes the above prism sheet, the surface of the prism sheet on the side opposite to the surface facing the light exit face of the light guide has the concavo-convex structure or formed as the second or first elongated prism formed surface, and the liquid crystal display element is directly mounted on the surface of the prism sheet of the surface light source device on the opposite side to the surface facing the light exit face of the light guide.

In one aspect of the present invention, the prism sheet has the concavo-convex structure or a flat structure, and a concavo-convex structure is formed on the surface of the liquid crystal display element that faces the prism sheet. In one aspect of the present invention, the concavo-convex structure of the liquid crystal display element has the same structure as the concavo-convex structure of the prism sheet.

Further, in order to solve the above problems, according to the present invention, there is provided a method for producing the above prism sheet, comprising:

producing a molding member having a shape transfer surface including a first region having a shape corresponding to or substantially corresponding to the elongated prisms or the first or second elongated prisms and a second region having a shape substantially corresponding to the valley portion or the first or second valley portion;

applying blasting treatment to the shape transfer surface of the molding member to make the shape of the second region corresponding to the valley portion or the first or second valley portion; and

forming the elongated prisms or the first or second elongated prisms on the surface of a synthetic resin sheet using the molding member.

In one aspect of the present invention, the blasting treatment is performed by spraying blasting particles having an average particle diameter 0.3 to 5 times the arrangement pitch of the elongated prisms or the first or second elongated prisms.

In one aspect of the present invention, the blasting treatment is performed by spraying blasting particles having an average particle diameter 0.3 to 5 times the arrangement pitch of the elongated prisms or the first or second elongated prisms, and further spraying blasting particles having an average particle diameter 0.1 to 0.5 times the arrangement pitch of the elongated prisms or the first or second elongated prisms.

### EFFECT OF THE INVENTION

According to the prism sheet having the configuration described above, the elongated prism formed surface has the roughened surface portion extending between the adjacent elongated prisms along the elongated prisms. Thus, in the surface light source device constituted by using the prism sheet, it is possible to obtain, based on the light diffusion property at the roughened surface portion, an effect of reducing the luminance unevenness due to poor formation of the prism sheet caused by a defect of a metallic mold for producing the prism sheet or due to adhesives of a protecting sheet for the elongated prisms remaining after peeling-off of the protecting sheet from the elongated prisms, that is an effect of concealing optical defects, without deterioration of accuracy in the light control function and reduction in the luminance.

Further, according to the prism sheet having the configuration described above, the elongated prism formed surface or first elongated prism formed surface has the valley portion or first valley portion having irregular cross-sectional shape which extends between the adjacent elongated prisms or first elongated prisms along the elongated prisms or first elongated prisms. Thus, in the surface light source device constituted by using the prism sheet, it is possible to obtain an effect of making the surface structure of the light guide difficult to visually recognized, that is an effect of concealing optical defects, without use of the light diffusion sheet and generating speckle.

Further, according to the prism sheet production method of the present invention, the production of the prism sheet having the above feature can be realized by adding a simple process of changing the shape of the shape transfer surface of the molding member used for transfer of the elongated prism formed surface or first elongated prism formed surface through the blasting treatment, and an increase in the production cost caused by the addition of the above process is small.

### BRIEF DESCRIPTION OF THE DRAWINGS

FIG. 1 is a perspective view schematically showing an embodiment of a surface light source device using a prism sheet according to the present invention;

FIG. 2 is a partial cross-sectional view schematically showing the surface light source device of FIG. 1;

FIG. 3 is a partly enlarged view schematically showing the prism sheet of FIG. 1;

FIG. 4 is a view schematically showing a state of light deflection by the prism sheet;

FIGS. 5A to 5C are cross-sectional views for explaining a production process of a molding member in an embodiment of a prism sheet production method according to the present invention;

FIG. 6 is a view schematically explaining molding of a synthetic resin sheet in an embodiment of a prism sheet production method according to the present invention;

FIG. 7 is a perspective view schematically showing a roll mold used in an embodiment of a prism sheet production method according to the present invention;

FIG. 8 is an exploded perspective view schematically showing a roll mold used in an embodiment of a prism sheet production method according to the present invention;

FIG. 9 is a diagram showing luminance distribution of the surface light source device;

FIG. 10 is a diagram showing luminance distribution of the surface light source device;

FIG. 11 is a partly enlarged cross-sectional view schematically showing an embodiment of the prism sheet according to the present invention;

FIG. 12 is a partly enlarged bottom view schematically showing the prism sheet of FIG. 11;

FIGS. 13A and 13B are views schematically showing a cross-section of a valley portion of the prism sheet of FIG. 11;

FIGS. 14A and 14B are views schematically showing a concavo-convex portion of a light exit surface of the prism sheet of FIG. 11;

FIG. 15 is a partly enlarged perspective view schematically showing an embodiment of the prism sheet according to the present invention;

FIG. 16 is a partly enlarged cross-sectional view schematically showing the prism sheet of FIG. 15;

FIG. 17 is a partly enlarged cross-sectional view schematically showing the prism sheet of FIG. 15;

FIG. 18 is a perspective view schematically showing an embodiment of the surface light source device using the prism sheet according to the present invention;

FIG. 19 is a view schematically showing an apparatus for producing a molding member used in an example;

FIG. 20 is an enlarged photograph of a cross-section of the shape transfer surface of elongated prisms and valley portions of a molding member blank obtained in the example;

FIG. 21 is an enlarged photograph of a cross-section of the shape transfer surface of elongated prisms and valley portions of a molding member obtained in the example; and

FIG. 22 is a view showing the distribution of dot-like concavo-convex portions.

### EXPLANATION OF REFERENCE SYMBOLS

1 primary light source
2 light source reflector
3 light guide
31 light incident end face
32 side end face
33 light exit face
34 rear surface
4 prism sheet
41 light incident surface
411 elongated prism
411a,411b prism surface
412 roughened surface portion
42 light exit surface
43 transparent substrate
44 prism portion
5 light reflection element
8 liquid crystal element
41′ molding member
411a′,411b′ first region
411a″,411b″ first region
412′ second region
412″ second region
BP blasting particle
7 molding member (roll mold)
9 transparent substrate
10 active energy ray-curable resin composition
11 pressure mechanism
12 resin tank
13 nozzle
14 active energy ray irradiating apparatus
15 thin plate-like molding member
16 cylindrical roll
18 shape transfer surface
28 nip roll
412A valley portion
413 ridge line of elongated prism
421 elongated prism
422A valley portion

### BEST MODE FOR CARRYING OUT THE INVENTION

Embodiments of the present invention will be described below with reference to the accompanying drawings.

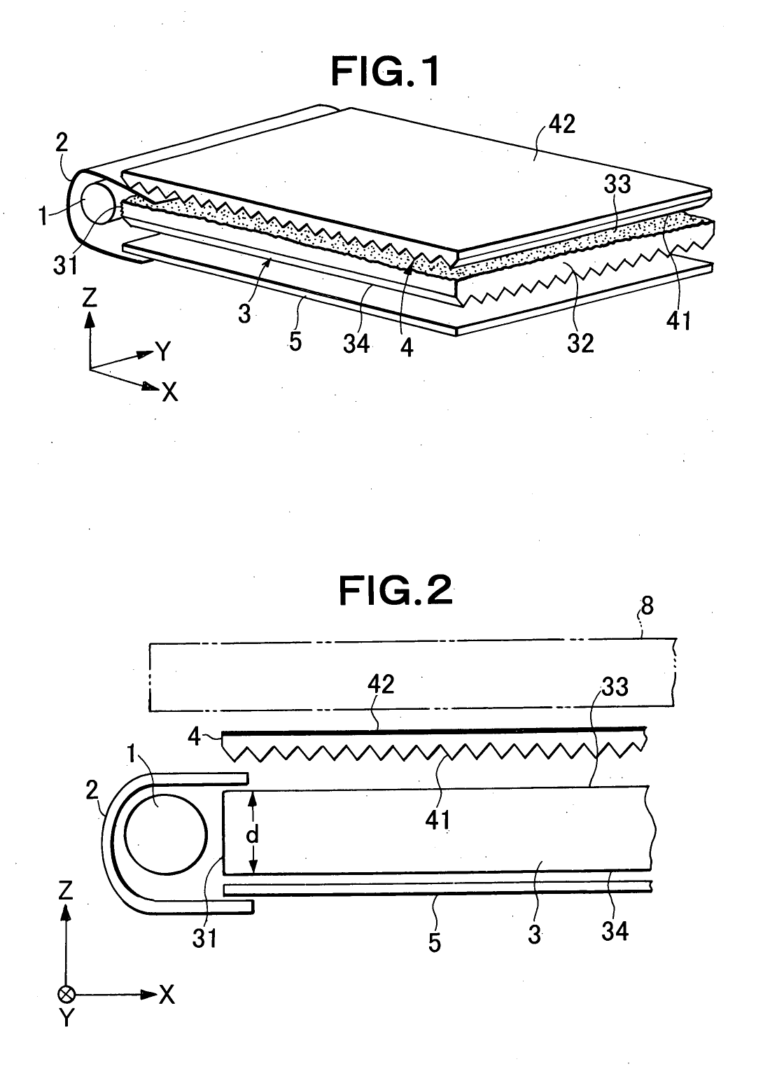

FIG. 1 is a schematic perspective view showing one embodiment of a surface light source device using a prism sheet according to the present invention and FIG. 2 is a schematic partial cross-sectional view thereof. As illustrated, the surface light source device of the present embodiment includes a light guide 3 having at least one side end face thereof as a light incident end face 31 and one face substantially orthogonally intersecting the light incident end face 31 as a light exit face 33, a primary light source 1 in a linear shape arranged in a manner facing the light incident end face 31 of the light guide 3 and covered with a light source reflector 2, a prism sheet 4 serving as a light deflection element arranged on the light exit face of the light guide 3, and a light reflection element 5 arranged in a manner facing a rear surface 34 of the light guide 3 on an opposite side to the light exit face 33.

The light guide 3 is arranged in parallel with an XY plane, and formed in a rectangular plate shape as a whole. The light guide 3 has four side end faces, among which at least one side end face of a pair of side end faces parallel with a YZ plane is the light incident end face 31. The light incident end face 31 is arranged in a manner facing a primary light source 1. Light emitted from the primary light source 1 is incident on the light incident end face 31 and introduced to the light guide 3. In the present invention, for example, another primary light source may be arranged in a manner facing any of other side end faces, such as a side end face 32 on an opposite side to the light incident end face 31.

Each of two principal faces substantially orthogonally intersecting the light incident end face 31 of the light guide 3 is positioned in substantial parallel relationship with the XY plane. One of the faces (a top face in FIGS. 1 and 2) is the light exit face 33. By providing a directional light exit mechanism including a rough surface on the light exit face 33, light with directivity on a plane (XZ plane) orthogonally intersecting the light incident end face 31 and the light exit face 33 is emitted from the light exit face 33 while the light introduced via the light incident end face 31 is guided in the light guide 3. An angle formed by a direction of a peak in an exit light luminance intensity distribution (peak light) in the distribution in the XZ plane with the light exit face 33 is α. The angle α is, for example, 10 to 40 degrees, and a full width at half maximum of the exit light luminance intensity distribution is, for example, 10 to 40 degrees.

The rough surface or elongated lens formed on the surface of the light guide 3 is preferably within a range that an average slant angle or average inclination angle θa according to ISO 4287/1-1984 is 0.5 to 15 degrees, in view of improving a uniformity of luminance in the light exit face 33. The average inclination angle θa is further preferably within a range of 1 to 12 degrees, and more preferably within a range of 1.5 to 11 degrees. The average inclination angle θa preferably has an optimum range set by a ratio (L/d) between a thickness (d) of the light guide 3 and a length (L) thereof in a direction in which incident light propagates. That is, in the case where the light guide 3 with L/d of around 20 to 200 is used, the average inclination angle θa is preferably 0.5 to 7.5 degrees, further preferably within a range of 1 to 5 degrees, and more preferably within a range of 1.5 to 4 degrees. In addition, in case the light guide 3 with L/d of around 20 or less is used, the average inclination angle ea is preferably 7 to 12 degrees, and more preferably within a range of 8 to 11 degrees.

The average inclination angle θa of the rough surface formed on the light guide 3 can be obtained by using the following formulas (1) and (2) from an inclination function f(x) obtained by measuring a shape of the rough surface by using a stylus type surface roughness measuring instrument in accordance with ISO4287/1-1984 where a coordinate in a measuring direction is x:

Δa=(1/L)∫₀^{L}|(d/dx)f(x)|dx (1)

θa=tan⁻¹(Δa) (2)

Here, L is a measuring length and Δa is a tangent of the average inclination angle θa.

Further, the light guide 3 preferably has a light exit rate within a range of 0.5 to 5% and more preferably within a range of 1 to 3%. When the light exit rate is made equal to or more than 0.5%, an amount of light emitted from the light guide 3 is increased, so that sufficient luminance tends to be obtained. Also, when the light exit rate is made equal to less than 5%, a large amount of light is prevented from being emitted in the vicinity of the primary light source 1, and attenuation of the emitted light in an X direction becomes smaller in the light exit face 33, and a uniformity of luminance tends to be increased in the light exit face 33. By setting the light exit rate of the light guide 3 at 0.5 to 5% as described above, the light guide 3 can emit light with an emitting characteristic of high directivity, where an angle of the peak light in the exit light luminance intensity distribution (in the XZ plane) of light emitted from the light exit face is within a range of 50 to 80 degrees with respect to a normal line of the light exit face, and a full width at half maximum of the exit light luminance intensity distribution (in the XZ plane) in the XZ plane perpendicular to both the light incident end face and the light exit face is within 10 to 40 degrees. Also, the prism sheet 4 can efficiently deflect the emitting direction of such light. In this manner, the surface light source device having high luminance can be provided.

In the present invention, the light exit rate from the light guide 3 is defined as follows. A relationship between a light intensity (I₀) of exit light at an end edge of the light exit face 33 on a side of the light incident end face 31 and an exit light intensity (I) at a position of the light exit face 33 of a distance L from the end edge thereof on the side of the light incident end face 31 satisfies the following formula (3) when a thickness (dimensions in a Z direction) of the light guide 3 is d:

I=I₀(α/100)[1−(α/100)]^{L/d} (3)

Here, a constant α is the light exit rate, and is a proportion (%) of light emission from the light guide 3 with respect to each unit length (a length equivalent to the thickness d of the light guide) in the X direction orthogonally intersecting the light incident end face 31 in the light exit face 33. The light exit rate α can be obtained on the basis of gradient obtained in a manner that, a logarithm of a light intensity of light emitted from the light exit face 33 is set on a vertical axis, (L/d) is set on a horizontal axis, and then relationships of these are plotted.

In the present invention, instead of, or together with, forming the light exit mechanism on the light exit face 33 as described above, a directional light exit mechanism can be provided by dispersing light diffusion fine particles in the inside of the light guide.

In addition, the rear surface 34 which is a principal face on which the directional light exit mechanism is not provided is configured as an elongated prism formed surface, on which a number of elongated prisms extending in a direction traversing the light incident end face 31, or more specifically in a direction (X direction) substantially perpendicular to the light incident end face 31, are arranged so as to control the directivity of light emitted from the light guide 3 on a plane (YZ plane) parallel with the primary light source 1. The arrangement pitch of the elongated prisms on the rear surface 34 of the light guide 3 may be, for example, within a range of 10 to 100 μm, and preferably within a range of 30 to 60 μm. An apex angle of the elongated prism on the rear surface 34 of the light guide 3 may be in a range of 85 to 110 degrees. When the prism apex angle is set to this range, the emitted light from the light guide 3 can be sufficiently condensed, and luminance of the surface light source device can be further enhanced. More preferably, the apex angle is within a range of 90 to 100 degrees.

The light guide 3 is not limited to the shape shown in FIG. 1. A variety of types of shapes, such as a wedge shape which has a larger thickness at an end edge on the side of the light incident end face, can be used.

The light guide 3 may be constituted by synthetic resin having high light transmittance. As such synthetic resin, methacrylate resin, acrylic resin, polycarbonate-based resin, polyester-based resin, and vinyl chloride-based resin may be exemplified. In particular, methacrylate resin excels in light transmittance, heat-resisting properties, mechanical characteristics, and molding processing properties, and is most suitable. Such methacrylate resin preferably is resin including methyl methacrylate as the major component, and includes methyl methacrylate at 80% by weight or higher. When a surface structure, such as a rough surface, and a surface structure, such as an elongated prism or a lenticular elongated lens, of the light guide 3 are formed, such surface structures may be formed by heat-pressing a transparent synthetic resin plate by using a molding member having a desired surface structure, or a shape may be provided simultaneously as molding by screen printing, extrusion molding, injection molding, and so on. In addition, the structure surfaces may be formed by using heat or photo-curing resin, or the like. Further, a rough surface structure made of active energy ray-curable resin or an elongated lens arranged structure may be formed on a surface of a transparent base material such as a transparent film, a transparent sheet, or the like made of polyester-based resin, acrylic-based resin, polycarbonate-based resin, vinyl chloride-based resin, polymethacrylimide-based resin, and the like. Such a sheet may be bonded and integrated with a separate transparent base material by a method such as bonding, fusing, and so on. As active energy ray-curable resin, a polyfunctional (meth)acrylic compound, a vinyl compound, (meth)acrylic acid esters, an allyl compound, metal salts of (meth)acrylic acid, or the like can be used.

The prism sheet 4 is arranged on the light exit face 33 of the light guide 3. Two principal faces or surfaces 41 and 42 of the prism sheet 4 are arranged in parallel with each other as a whole, and positioned in parallel with the XY plane as a whole. One of the principal faces 41 and 42 (a principal face positioned in a manner facing the light exit face 33 of the light guide 3) is a light incident surface 41, and the other is a light exit surface 42. The light exit surface 42 is a flat surface in parallel with the light exit face 33 of the light guide 3. The light incident surface 41 is an elongated prism formed surface having a number of elongated prisms 411 extending in a Y direction and arranged in parallel with each other.

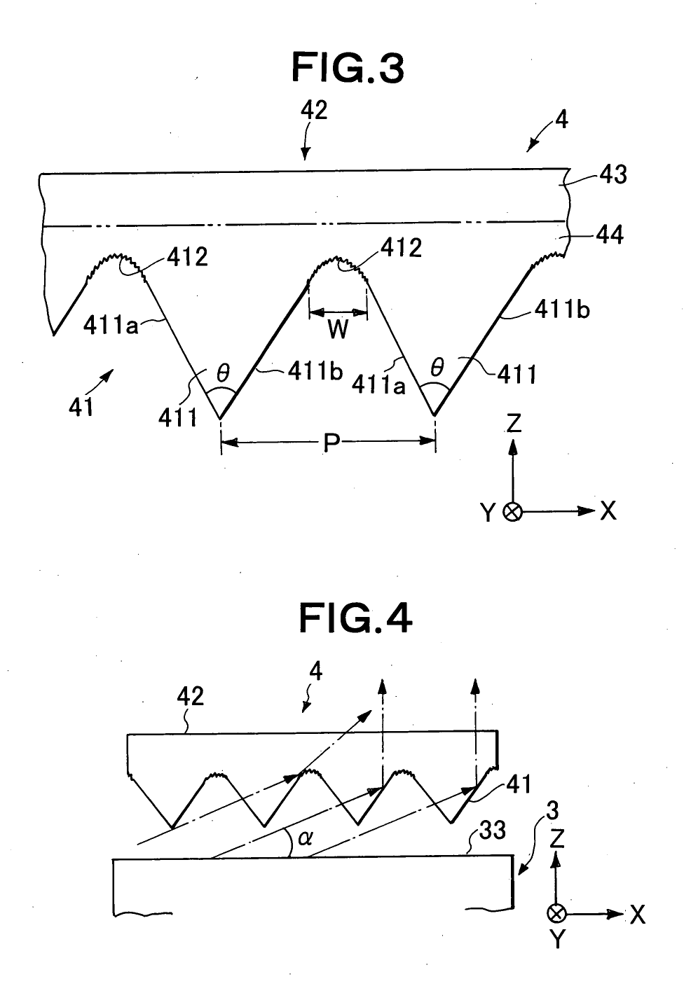

FIG. 3 is a partly enlarged view schematically showing the prism sheet 4. The prism sheet 4 may be constituted by a transparent substrate 43 and a prism portion 44. In this case, the upper surface of the transparent substrate 43 serves as the light exit surface 42, and lower surface of the prism portion 44 serves as the light incident surface 41.

The transparent substrate 43 is preferably made of a material that can transmit active energy ray such as ultraviolet rays and electron beam. Although a flexible glass plate or the like can be exemplified as such a material, it is preferable to use a transparent sheet or transparent film made of polyester-based resin, acrylic-based resin, polycarbonate-based resin, vinyl chloride-based resin, polymethacrylimide-based resin, and the like. In particular, it is preferable to use a transparent sheet or transparent film made of polyester-based resin having a lower refractive index than that of prism portion 44 and having a lower surface reflectance, such as polymethyl methacrylate, mixture of polymethyl acrylate and polyvinylidene-fluoride-based resin, polycarbonate-based resin, and polyethylene terephthalate. The thickness of the transparent substrate 43 is, e.g., about 50 to 500 μm. Preferably, in order to increase the adhesiveness between the prism portion 44 made of active energy ray-curable resin and transparent substrate 43, adhesiveness-improving treatment such as anchor coating is applied to the surface of the transparent substrate 43.

The upper surface of the prism portion 44 is made flat and bonded to the lower surface of the transparent substrate 43. The lower surface, i.e., light incident surface 41 of the prism portion 44 is an elongated prism formed surface on which a plurality of elongated prisms 411 extending in Y direction are arranged in parallel to each other. Further, roughened surface portions 412 extending in Y direction along the elongated prisms are arranged between the adjacent elongated prisms. The thickness of the prism portion 44 is e.g., 10 to 500 Mm. An arrangement pitch P of the elongated prisms 411 is, e.g., 10 to 500 μm.

Each of the elongated prisms 411 includes two prism surfaces 411a and 411b. These prism surfaces may be formed as a flat surface (mirror surface) so as to obtain stable optical performance or as a rough surface whose roughening degree is smaller than that of the roughened surface portions 412. In the present invention, it is preferable to form the prism surface as a mirror surface in order to maintain desired optical characteristics. In this case, a portion of the prism surface near the roughened surface portion may be roughened. The roughening degree indicates the degree of roughening of a surface and can be represented by center-line average roughness Ra or ten-point average roughness Rz. An apex angle θ of each of the elongated prisms 411 is preferably set in the range of 40 to 150 degrees. Typically, in a backlight of a liquid crystal display device, when the prism sheet is arranged such that the elongated prism formed surface thereof faces a liquid crystal panel, the apex angle θ of each of the elongated prisms is set in the range of 80 to 100 degrees and, preferably, in the range of 85 to 95 degrees. On the other hand, when the prism sheet 4 is arranged such that the elongated prism formed surface thereof faces the light guide 3, the apex angle θ of each of the elongated prisms 411 is set in the range of 40 to 75 degrees and, preferably, in the range of 45 to 70 degrees.

The width W of the roughened surface portion 412 is preferably set in the range of 0.04 to 0.5 times the arrangement pitch P of the elongated prisms 411, more preferably in the range of 0.08 to 0.3 times, and most preferably in the range of 0.1 to 0.2 times. This is because when the width W of the roughened surface portion 412 is set in the range of 0.04 to 0.5 times the arrangement pitch P, a light concentration effect toward a desired observation direction range and satisfactory luminance unevenness reducing effect can be obtained based on the light diffusion in the roughened surface portion 412, as well as a reduction in a light deflection effect toward the normal line of the light guide light exit face produced by the elongated prisms 411 can be suppressed. The roughening degree of the surface of the roughened surface portion 412 is set in the range of 0.3 to 2 μm, and preferably in the range of 0.4 to 1.7 μm in terms of center-line average roughness Ra, and is set in the range of 1 to 3 μm, and preferably in the range of 1.3 to 2.7 μm in terms of ten-point average roughness Rz. These roughening values can be obtained by measuring the surface shape of the roughened surface portion 412 at the central portion (i.e., valley floor portion) by 100 μm range along the extending direction of the roughened surface portion 412.

The two prism surfaces 411a and 411b of each of the elongated prisms 411 may each have a rough surface having a smaller roughening degree than that of the surface of the roughened surface portion 412. The roughening degree of each of the prism surfaces 411a and 411b is set to less than 0.3 μm, and preferably to 0.1 μm or less in terms of center-line average roughness Ra, and is set to less than 1 μm, and preferably to 0.5 μm or less in terms of ten-point average roughness Rz. These roughening values can be obtained based on the surface shape of a unit length (100 μm) of the prism surfaces 411a and 411b along the extending direction thereof. When the roughening degree of the prism surfaces 411a and 411b is made smaller than that of the surface of the roughened surface portion 412, it is possible to reduce light deflection at the prism surfaces 411a and 411b to thereby suppress a reduction in a light deflection effect toward the normal line of the light guide light exit face produced by the elongated prisms 411.

The surface shapes of the roughened surface portion 412 and prism surfaces 411a and 411b of each of the elongated prisms 411 can be measured by using a super depth profile measurement microscope (e.g., VK-8500 [trademark] manufactured by Keyence Corp.).

The entire shape of the XZ cross-section of the roughened surface portion 412 without considering the shape of the fine structure of the roughened surface portion 412 (or the entire shape of the XZ cross-section of the roughened surface portion 412 in which the shape of the roughened surface portion 412 is averaged to smooth the irregularity) curves in a reversed U-like shape outwardly, i.e., downwardly as illustrated. Alternatively, the entire shape of XZ cross-section of the roughened surface portion 412 may be a flat surface parallel to the XY plane.

In the present invention, the roughened surface portion and prism surface are distinguished based on the roughening degree. That is, a portion having a larger roughening degree is defined as the roughened surface portion, and a mirror surface portion or portion having a smaller roughening degree is defined as the prism surface.

The prism portion 44 is made of, e.g., active energy ray-curable resin. It is preferable to use active energy ray-curable resin having a high refractive index in terms of an increase in the luminance of the surface light source device. More specifically, the active energy ray-curable resin preferably has a refractive index of 1.1.48 or more, and more preferably 1.50 or more. The active energy ray-curable resin that forms the prism portion 44 may be any one, as long as it is cured by active energy ray such as ultraviolet rays and electron beam; examples thereof include polyesters, epoxy-based resin, and (meth)acrylate-based resin such as polyester (meth)acrylate, epoxy (meth)acrylate, and urethane (meth)acrylate. Among them, (meth)acrylate-based resin is particularly preferable in terms of its optical properties and the like. An active energy ray-curable resin composition used for the active energy ray-curable resin preferably contains, as main components, polyfunctional acrylate and/or polyfunctional methacrylate (referred hereinafter to as “polyfunctional (meth)acrylate”), mono-acrylate and/or mono-methacrylate (referred hereinafter to as “mono (meth)acrylate”), and initiator for photopolymerization based on the active energy ray in terms of handling and curing property. Examples of polyfunctional (meth)acrylate include polyol poly (meth)acrylate, polyester poly (meth)acrylate, epoxy poly (meth)acrylate, and urethane poly (meth)acrylate. These may be used alone or in combination of two or more. Examples of mono (meth)acrylate include mono (meth)acrylic ester of monoalcohol and mono (meth)acrylic ester of polyol.

Although the prism sheet 4 is constituted by the transparent substrate 43 and prism portion 44 in the above description, the prism sheet 4 according to the present invention may be made of a single material. In this case, the prism sheet 4 may be made of synthetic resin having high light transmittance. As such synthetic resin, methacrylate resin, acrylic resin, polycarbonate-based resin, polyester-based resin, and vinyl chloride-based resin may be exemplified. In particular, methacrylate resin excels in light transmittance, heat-resisting properties, mechanical characteristics, and molding processing properties, and is most suitable. Such methacrylate resin preferably is resin including methyl methacrylate as the major component, and includes methyl methacrylate at 80% by weight or higher.

FIG. 4 schematically shows a state of light deflection by the prism sheet 4 in the XZ plane. FIG. 4 shows one example of an advancing direction of the peak light (light corresponding to a peak of the exit light distribution) from the light guide 3 in the XZ plane. Most part of the peak light emitted obliquely in an angle of α from the light exit face 33 of the light guide 3 enters the first prism surfaces 411a of the elongated prisms 411, is totally internally reflected by the second prism surfaces 411b, and outgoes in a direction of a substantial normal line of the light exit surface 42. In addition, a part of the peak light enters the first prism surfaces 411a of the elongated prisms 411, is diffused by the roughened surface portions 412, and outgoes from the light exit surface 42. This light diffusion is observed also in the YZ plane. A part of the light other than the peak light directly enters the roughened surface portions 412 and is then diffused. By the above light diffusion at the roughened surface portions 412, a light concentration effect toward a desired observation direction range and satisfactory luminance unevenness reducing effect can be obtained. Further, in the YZ plane, by action of the elongated prisms of the rear surface 34 of the light guide as described above, sufficient improvement of luminance of the light exit surface 42 in the normal line direction in a wide range of a region can be attained.

The shape of each of the prism surfaces 411a and 411b of the elongated prism 411 of the prism sheet 4 is not limited to a single flat surface, and may be a cross-sectionally convex and polygonal shape or a convex curved surface shape. In this manner, higher luminance or narrower view can be attained.

In the prism sheet 4, a top-flat part or a top-curved surface part may be formed at the apex portion of the elongated prism, for the purpose of producing a desired elongated prism shape, obtaining stable optical performance, and also preventing abrasion and deformation of the prism apex portion at the time of assembly work and at the time of being used as a light source device. In this case, a width of the top-flat part and the top-curved surface part is preferably 3 μm or less in view of preventing reduction in luminance and generation of an uneven pattern of luminance due to a sticking phenomenon. More preferably, the width of the top-flat part or the top-curved surface part is 2 μm or less, and further preferably 1 μm or less.

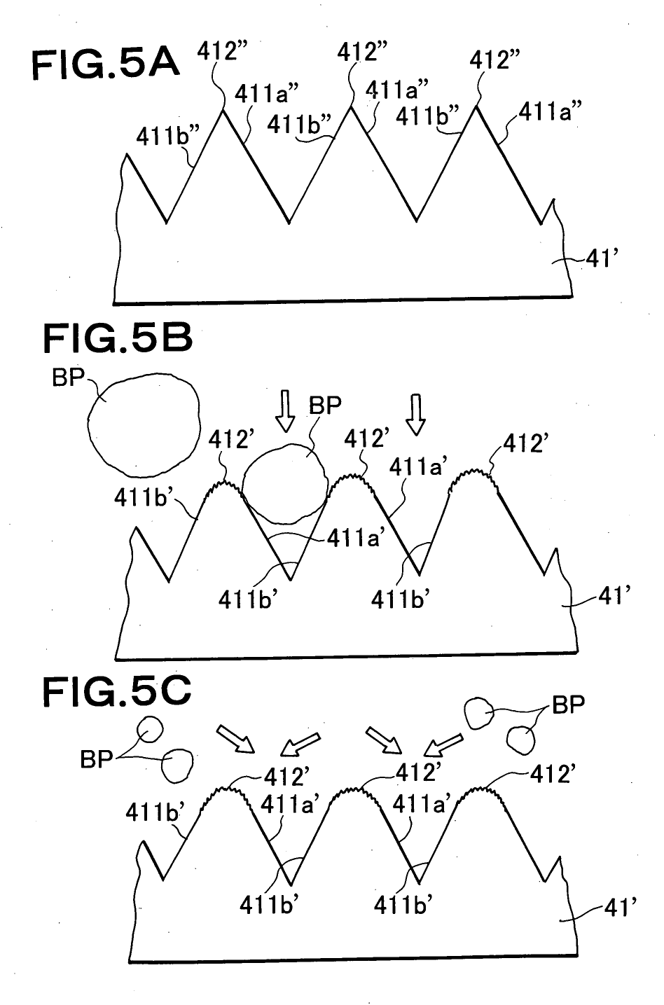

The prism sheet 4 having the configuration described above can be produced by molding the surface of the synthetic resin sheet using a molding member having a shape transfer surface that transfers and forms the light incident surface 41 which is the elongated prism formed surface including the elongated prisms 411 and roughened surface portions 412. The production of the molding member will be described with reference to FIGS. 5A to 5C.

As shown in FIG. 5A, a molding member 41′ is first produced. The molding member 41′ has a shape transfer surface including a first region 411a″-411b″ having a shape substantially corresponding to the prism surfaces 411a and 411b of the elongated prism 411 and a second region 412″ having a shape corresponding to the roughened surface portion 412. The shape “substantially corresponding to the roughened surface portion 412” indicates a shape from which a shape corresponding to the roughened surface portion 412 can be obtained by application of blasting treatment. For example, the shape of the second region 412″ can be obtained by extending the shape (e.g., flat surfaces) formed by the first region 411a″-411b″.

Subsequently, blasting treatment is applied to the shape transfer surface of the molding member 41′ to roughen the second region 412″ so as to make the shape of the second region 412″ corresponding to the roughened surface portion 412. The blasting treatment is performed such that blasting particles are not substantially sprayed to the first region 411a″-411b″ of the molding member 41′ but sprayed only to the second region 412″. Specifically, for example, blasting treatment is carried out using blasting particles having a size (particle diameter) that cannot go deep into the concave portion of the molding member 41′. In the case where the blasting particles are sprayed from above with respect to the cross-section shown in FIG. 5B, the particle diameter of blasting particles BP is appropriately set in a predetermined range in accordance with the apex angle θ and pitch P of the elongated prisms. For example, when the prism apex angle θ is set in the range of 40 to 75 degrees, the particle diameter can be set to a value 0.3 times the pitch P or more. When the particle diameter of the blasting particles BP is too large, the roughening degree becomes small, so that the particle diameter is preferably set to a value about 5 times the pitch P at a maximum. The particle diameter of the blasting particles BP is more preferably set in the range of 1 to 4 times the pitch P, and most preferably set in the range of 2 to 3 times the pitch P. The blasting pressure may appropriately be set in accordance with the material and particle size of the blasting particles to be used and material of the molding member 41′. For example, the blasting pressure can be set to 0.01 to 1 MPa. By carrying out the above blasting treatment for an appropriate time period, the molding member 41′ as shown in FIG. 5B having a shape transfer surface including a first region 411a′-411b′ having a shape corresponding to the prism surfaces 411a and 411b of the elongated prism 411 and a second region 412′ having a shape corresponding to the roughened surface portion 412 can be obtained.

In the blasting treatment, the blasting particles BP can be sprayed obliquely from above as shown in FIG. 5C. In this case, blasting particles having a smaller diameter than that in the case of FIG. 5B can be used. Further, by appropriately setting the spraying angle of the blasting particles, the width of the second region 412′ having a shape corresponding to the roughened surface portion can desirably be determined.

The above description shows a case where the prism surfaces 411a and 411b of the elongated prism 411 are optically sufficiently smooth. The first region 411a″-411b″ of the molding member 41′ has already been formed into a shape corresponding to the prism surfaces 411a and 411b before the blasting treatment, and this region is less influenced by the blasting treatment. However, the blasting particles may include flattened particles and, in this case, the blasting influences the first region 411a″-411b″. In such a case, the first region 411a″-411b″ is slightly roughened by the blasting treatment with the result that the first region 411a′-411b′ that has slightly been roughened is obtained. That is, the prism surfaces 411a and 411b of the elongated prism 411 are formed into slightly roughened surfaces having a smaller roughening degree than that of the surface of the roughened surface portion 412.

The prism surfaces 411a and 411b of the elongated prism 411 may intentionally be formed into roughened surfaces having a smaller roughening degree than that of the surface of the roughened surface portion 412. In this case, the first region 411a″-411b″ of the molding member 41′ is formed into a shape substantially corresponding to the shape of the prism surfaces 411a and 411b before the blasting treatment. The shape “substantially corresponding to the prism surfaces 411a and 411b” indicates a shape from which a shape corresponding to the prism surfaces 411a and 411b can be obtained by application of blasting treatment. By applying the blasting treatment (first blasting treatment) as described above to roughen the second surface 412″, as well as by applying second blasting treatment in which blasting particles having a smaller particle diameter are sprayed to roughen the first region 411a″-411b″ so as to make the shape of the first region 411a″-411b″ corresponding to the shape of the prism surfaces 411a and 411b of the elongated prisms 411 and make the shape of the second region 412″ corresponding to the shape of the roughened surface portion 412. The particle diameter of the blasting particles used in the second blasting treatment may be set in the range of 0.1 to 0.5 times the arrangement pitch P of the elongated prisms.

The molding member produced as described above and a molding member having a planer shape transfer surface are used to perform molding for a synthetic resin, whereby a prism sheet can be obtained. That is, the prism sheet having a required elongated prism formed surface can be obtained by molding the surface of the synthetic resin sheet using the molding members as described above. The molding of the surface of the synthetic resin sheet can be carried out by heat press, extrusion molding, injection molding, or the like.

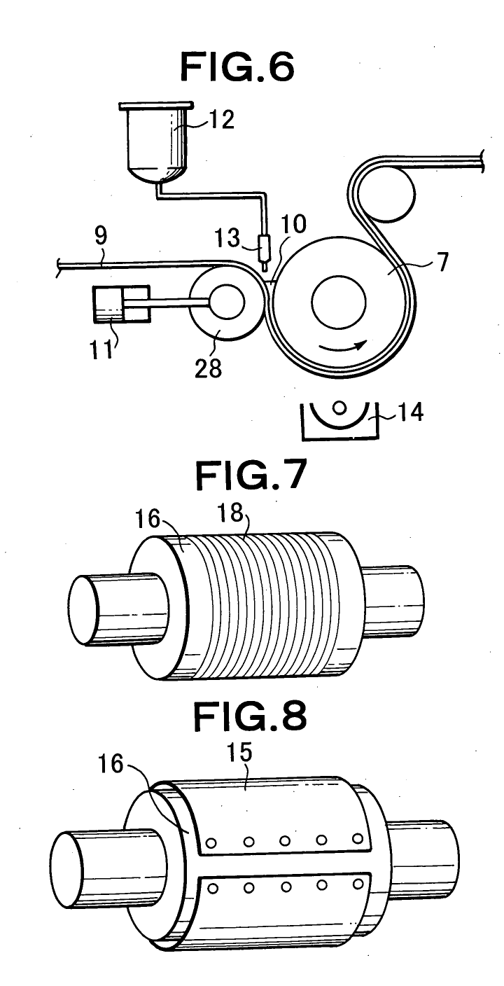

FIG. 6 is a view schematically showing another embodiment of the molding of a synthetic resin sheet.

In FIG. 6, reference numeral 7 is a molding member (roll mold) having the same shape transfer surface as that of the molding member 41′ formed on its cylindrical outer circumferential surface. The roll mold 7 may be made of metal such as aluminum, brass, or steel. FIG. 7 is a perspective view schematically showing the roll mold 7. A shape transfer surface 18 is formed on the outer circumferential surface of the cylindrical roll 16. The blasting treatment as described above for forming the shape transfer surface 18 can be carried out with high accuracy and satisfactory productivity while rotating the roll mold. FIG. 8 is an exploded perspective view schematically showing a modification of the roll mold 7. In this modification, a thin plate-like molding member 15 is wound around the outer circumferential surface of the cylindrical roll 16 for fixing. The thin plate-like molding member 15 is the same one as the molding member 41′ and has a shape transfer surface formed on the outer surface. The blasting treatment as described above for forming the shape transfer surface can be carried out for the molding member 15 in a planar state, that is, for one removed from the cylindrical roll 16. However, by carrying out the blasting treatment for the molding member 15 in a state where it is wound around the outer circumferential surface of the cylindrical roll 16 while rotating it, processing accuracy can be increased.

As shown in FIG. 6, a transparent substrate 9 is fed to the roll mold 7 along its outer circumferential surface, i.e., shape transfer surface, and an active energy ray-curable resin composition 10 is sequentially supplied between the roll mold 7 and transparent substrate 9 through a nozzle 13 from a resin tank 12. A nip roll 28 is provided outside the transparent substrate 9 so as to uniform the thickness of the supplied active energy ray-curable resin composition 10. As the nip roll 28, a metallic roll, rubber roll, or the like is used. In order to uniform the thickness of the active energy ray-curable resin composition 10, it is preferable to use the nip roll 28 whose circularity and surface roughness are achieved and adjusted with high accuracy. In the case of the rubber roll, the rubber hardness is preferably 60 degrees or more. The nip roll 28 is required to accurately adjust the thickness of the active energy ray-curable resin composition 10 and is operated by a pressure mechanism 11. The pressure mechanism 11 may be a hydraulic cylinder, pneumatic cylinder, or various screw mechanisms. Among these, the pneumatic cylinder is preferable in terms of mechanical simplicity. The pneumatic pressure is controlled by a pressure-regulating valve or the like.

The viscosity of the active energy ray-curable resin composition 10 supplied between the roll mold 7 and transparent substrate 9 is preferably maintained at a constant value so as to make the thickness of the obtained prism portion constant. In general, the viscosity of the active energy ray-curable resin composition 10 is preferably set in the range of 20 to 3000 mPa·s, and more preferably in the range of 100 to 1000 mPa·s. Setting the viscosity of the active energy ray-curable resin composition 10 to 20 mPa·s or more eliminates the need to set the nip pressure to an extremely low value or extremely increase the molding speed in order to make the thickness of the prism portion constant. When the nip pressure is set to an extremely low value, the operation of the pressure mechanism 11 tends to become unstable, making it difficult to make the thickness of the prism portion constant. Further, when the molding speed is extremely increased, the irradiation amount of the active energy ray becomes insufficient, with the result that the curing of the active energy ray-curable resin composition tends to become insufficient. When the viscosity of the active energy ray-curable resin composition 10 is set to 3000 mPa·s or less, the active energy ray-curable resin composition 10 can sufficiently be supplied to the minute parts of the shape transfer surface structure of the roll mold, thereby preventing difficulty in accurate transfer of the lens shape, easy occurrence of a defect due to introduction of air bubbles, deterioration of productivity due to extreme decrease in the molding speed. Thus, in order to maintain the viscosity of the active energy ray-curable resin composition 10 at a constant value, it is preferable to provide a heat source equipment such as a sheathed heater or hot water jacket inside or outside the resin tank 12 so that the temperature of the active energy ray-curable resin composition 10 can be controlled.

After the active energy ray-curable resin composition 10 is supplied between the roll mold 7 and transparent substrate 9, an active energy ray is irradiated from an active energy ray irradiating apparatus 14 through the transparent substrate 9 in a state where the active energy ray-curable resin composition 10 is sandwiched between the roll mold 7 and transparent substrate 9 to polymerize and cure the active energy ray-curable resin composition 10 so as to perform transfer of the shape transfer surface formed on the roll mold 7. As the active energy ray irradiating apparatus 14, a chemical lamp for chemical reaction, a low-pressure mercury lamp, a high-pressure mercury lamp, a metal halide lamp, a visible light halogen lamp, or the like can be used. Regarding the irradiation amount, preferably, the active energy ray irradiation is carried out so that integrated energy of a wavelength of 200 to 600 nm can be set to 0.1 to 50 J/cm². An irradiation atmosphere of the active energy ray may be in air or in inert gas such as nitrogen or argon. Subsequently, a prism sheet constituted by the transparent substrate 9 (the transparent substrate 43) and prism portion (the prism portion 44) formed by the active energy ray-curable resin is removed from the roll mold 7.

Returning to FIG. 1, the primary light source 1 is a linear light source extending in the Y direction. As the primary light source 1, for example, a fluorescent lamp or a cold cathode tube can be used. In this case, the primary light source 1 is not only provided in a manner facing one side end face of the light guide 3 as shown in FIG. 1, but may also be provided on a side end face opposite thereto as necessary.

The light source reflector 2 reduces loss of light when light from the primary light source 1 is guided to the light guide 3. As a material for the light source reflector 2, for example, a plastic film having a metal-evaporated reflective layer on a surface thereof may be used. As illustrated, the light source reflector 2 is wrapped around from an outer surface of an end edge part of the light reflection element 5, via an outer surface of the primary light source 1, and to an end edge part of the light exit face of the light guide 3, in a manner avoiding the prism sheet 4. On the other hand, the light source reflector 2 may be wrapped around from an outer surface of an end edge part of the light reflection element 5, via an outer surface of the primary light source 1, and to an end edge part of the light exit surface of the prism sheet 4. A reflective member similar to the light source reflector 2 may be attached to a side end face of the light guide 3 other than the light incident end face 31.

As the light reflection element 5, for example, a plastic sheet having a metal-evaporated reflection layer on a surface thereof may be used. In the present invention, as the light reflection element 5, a light reflection layer or the like formed by metal evaporation or the like on the rear surface 34 of the light guide 3 may be used in place of a reflection sheet.

By arranging a transmission-type liquid crystal display element 8 on a light emitting surface (the light exit surface 42 of the prism sheet 4) of the surface light source device including the primary light source 1, the light source reflector 2, the light guide 3, the prism sheet 4, and the light reflection element 5 as shown in FIG. 2, a liquid crystal display device having the surface light source device of the present invention as a backlight can be constituted. The liquid crystal display device is observed by an observer from the above in FIG. 2.

In the present embodiment, the function of the prism sheet 4 having the above feature makes it possible to reduce the luminance unevenness while suppressing a reduction in the luminance. In particular, on the prism sheet 4, the elongated prisms 411 are formed at the apex portions and in the vicinity of the apex portions that contribute greatly to a light deflection function, and roughened surface portions 412 are formed at portions between the adjacent elongated prisms 411 that contribute a little to a light deflection function, so that it is possible to satisfactorily exhibiting a function of concealing the optical defects such as the luminance unevenness and the like while favorably exhibiting a required light deflection function.

FIG. 11 is a partly enlarged cross-sectional view schematically showing an embodiment of the prism sheet according to the present invention, and FIG. 12 is a partly enlarged bottom view schematically showing the prism sheet of FIG. 11. In FIGS. 11 and 12, the same reference numerals as those in FIGS. 1 to 10 denote the parts having the same functions as those in FIGS. 1 to 10.

As shown in FIGS. 11 and 12, a prism sheet according to the present embodiment is the same as the prism sheet of the above embodiment in the point that the light incident surface 41 which is the elongated prism formed surface has a plurality of elongated prisms 411 extending in the Y-direction in parallel to each other. Further, the elongated prism formed surface 41 has valley portions 412A extending in the Y-direction between the adjacent elongated prisms 411. As in the case of the width W of the roughened surface portions 412 in the above embodiment, a width WA of the valley portions 412A is preferably set in the range of 0.04 to 0.5 times the arrangement pitch P of the elongated prisms 411, more preferably in the range of 0.08 to 0.3 times, and most preferably in the range of 0.1 to 0.2 times. In FIGS. 11 and 12, the ridge lines of the elongated prisms 411 are indicated by reference numeral 413.

The valley portions 412A have irregular cross-sectional shapes. The term “irregular” means here that a pattern of the cross-sectional shapes sampled for each elongated prism arrangement pitch P in a given domain of a predetermined size with respect to both in the extending direction (Y-direction) of the elongated prisms 411 and arrangement direction (X-direction) thereof differs from a pattern in another given domain. A predetermined size of the domain can be set to 500 μm with respect to both in the Y-direction and X-direction. Assuming that the arrangement pitch P of the elongated prisms 411 is 100 μm, the valley portions 412A existing at the X-direction coordinates x1 to x5 are sequentially arranged in the X-direction at the elongated prism arrangement pitch P, as shown in FIG. 12. Five cross-sectional shapes of the respective five sequentially arranged valley portions 412A are sampled by taking along the respective planes of the Y-axis coordinates y1 to y5 spaced apart from each other by the elongated prism arrangement pitch P. That is, in total, 25 cross-sectional shapes are sampled from (x1, y1) to (x5, y5) on the XY coordinate. The region having a pattern including the 25 cross-sectional shapes thus obtained is set as one domain. When patterns each including 25 cross-sectional shapes in arbitrary two domains are not the same, it can be said that the valley portion cross-sectional shapes are irregular. With regard to the 25 cross-sectional shapes in each domain, more than half (i.e., 13 or more) preferably differ from any other cross-sectional shapes, and more preferably all the 25 cross-sectional shapes differ from any other cross-sectional shapes.

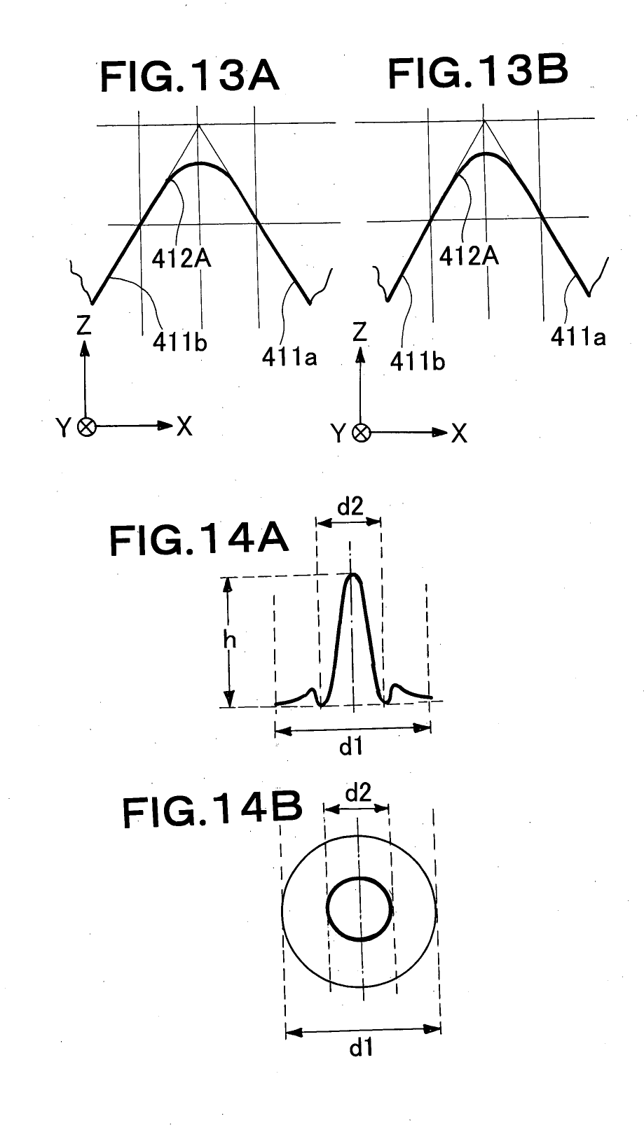

Here, the difference in the valley portion cross-sectional shapes means that a significant difference occurs in the optical function of reflecting or refracting the incoming light from the light guide 3 described in FIG. 4. For example, when two cross-sectional shapes of the elongated prism are sampled in its extending direction at positions spaced apart from each other by the elongated prism arrangement pitch P in the elongated prism that has been obtained by mechanically cutting the synthetic resin member using a tool bit, the cross-sectional shapes are substantially the same and there is substantially no difference in the optical function. On the other hand, when the valley portion cross-sectional shapes differ from each other, there is no sameness in the shape and optical function of such degree. FIGS. 13A and 13B each show XZ cross-sections of a valley portion 412A. FIGS. 13A and 13B show different valley portion cross-sectional shapes.

The above description assumes a case where the arrangement pitch P of the elongated prisms 411 is 100 μm. Then, assuming that the arrangement pitch P of the elongated prisms 411 is 50 μm, in total, 100 cross-sectional shapes are sampled from (x1, y1) to (x10, y10) on the XY coordinate. The region having a pattern including the 100 cross-sectional shapes thus obtained is set as one domain. When patterns each including 100 cross-sectional shapes in arbitrary two domains are not the same, it can be said that the valley portion cross-sectional shapes are irregular. With regard to the 100 cross-sectional shapes in each domain, more than half (i.e., 50 or more) preferably differ from any other cross-sectional shapes, and more preferably all the 100 cross-sectional shapes differ from any other cross-sectional shapes.

The valley portions 412A having the irregular shapes described above can be obtained by molding the surface of the synthetic resin sheet using a molding member having a shape transfer surface that has been subjected to the blasting treatment with blasting particles having an average particle diameter 0.3 to 5 times the elongated prism arrangement pitch P as described in the above embodiment. Although the description concerning FIGS. 11 to 13B does not refer to the fine structure of the valley portions 412A, the valley portions 412A may have the fine structure having a surface roughness as described in the above embodiment.

In the case where a surface light source device is constituted using the prism sheet according to the present embodiment in the same manner as the above embodiment, the valley portions 412A having irregular cross-sectional shapes are formed on the elongated prism formed surface 41 of the prism sheet. The valley portions 412A diffuse or reflect the incoming light from the light guide thereby making it difficult to visualize the surface structure of the light guide. In particular, on the prism sheet 4, the elongated prisms 411 are formed at the apex portions and in the vicinity of the apex portions that contribute greatly to a light deflection function, and valley portions 412A having irregular cross-sectional shapes are formed at portions between the adjacent elongated prisms that contribute a little to a light deflection function, so that it is possible to satisfactorily exhibit a function of concealing the optical defects such as easy visibility of the surface structure of the light guide while favorably exhibiting a required light deflection function.

According to the present embodiment, with a simple means for forming only the cross-sectional shapes of the valley portions into irregular shapes while maintaining the cross-sectional shapes of the elongated prisms, that is, simply by adding blasting treatment for the molding member in terms of an actual production means, it is possible to conceal the optical defects causing the luminance unevenness attributed to the structure of the light guide at low cost and without reduction in the luminance and occurrence of speckle.

In the present embodiment, the light exit surface 42 which is the surface of the prism sheet opposite to the elongated prism formed surface 41 has a concavo-convex structure and, in particular, a slightly concavo-convex structure.

In another viewpoint, the slightly concavo-convex structure of the light exit surface 42 has preferably an arithmetic average roughness Ra of 0.01 μm to 0.05 μm, and more preferably, 0.015 μm to 0.03 μm.

In another viewpoint, the slightly concavo-convex structure of the light exit surface 42 has preferably a roughness curve maximum valley depth Ry of 0.1 μm to 0.5 μm, and more preferably, 0.2 μm to 0.4 μm.

In another viewpoint, the slightly concavo-convex structure of the light exit surface 42 has preferably a ten-point average roughness Rz of the roughness curve of 0.1 μm to 0.5 μm, and more preferably, 0.15 μm to 0.4 μm.

In another viewpoint, the slightly concavo-convex structure of the light exit surface 42 has preferably a roughness curve element average length Sm of 50 μm to 900 μm, more preferably, 60 μm to 150 μm, and most preferably 70 μm to 90 μm.

In another view point, the slightly concavo-convex structure of the light exit surface 42 has preferably a roughness curved surface arithmetic average slant RΔa of 0.1 degrees to 1 degree, more preferably, 0.2 degrees to 0.8 degrees, and most preferably 0.3 degrees to 0.6 degrees.

The above arithmetic average roughness Ra, roughness curve maximum valley depth Ry, roughness curve ten-point average roughness Rz, roughness curve element average length Sm, and roughness curved surface arithmetic average slant RΔa can be measured using a method specified in JIS94.

When the respective values of the above average slant angle, arithmetic average roughness Ra, roughness curve maximum valley depth Ry, roughness curve ten-point average roughness Rz, roughness curve element average length Sm, and roughness curved surface arithmetic average slant RΔa of the light exit surface 42 are smaller than their lower limit values, sticking between the prism sheet 4 and liquid crystal element 8 disposed on the light exit surface 42 of the prism sheet 4 is likely to occur, while the respective values thereof are larger than their upper limit values, the diffusing property of the light on the light exit surface 42 of the prism sheet 4 becomes too high with the result that speckle may occur and, further, reduction in the luminance in a desired observation direction range may occur. That is, when the respective values of the average slant angle, arithmetic average roughness Ra, roughness curve maximum valley depth Ry, roughness curve ten-point average roughness Rz, roughness curve element average length Sm, and roughness curved surface arithmetic average slant RΔa fall within the above preferable ranges, the sticking between the prism sheet 4 and liquid crystal element 8, speckle, and reduction in the luminance in a desired observation direction range are hard to occur.

As the slightly concavo-convex structure of the light exit surface 42, one constituted by discretely distributed (that is, assumes dot-like shape) concavo-convex portions can be exemplified. FIGS. 14A and 14B each schematically show the concavo-convex portion. FIG. 14A is a cross-sectional view and FIG. 14B is a plan view. The concavo-convex portion includes a center portion and a ring portion. The center portion is located at the center of the concavo-convex portion and forms a main concavo-convex shape. The ring portion has a shape having a comparatively small difference in height. The ring portion is located around the center portion and continues to the peripheral portion thereof. The outer diameter of the concavo-convex portion, i.e., the outer diameter of the ring portion is d1, the diameter of the center portion is d2, and height or depth of the concavo-convex portion is h.

The outer diameter d1 of the concavo-convex portion is preferably set in the range of 10 μm to 60 μm, more preferably in the range of 15 μm to 40 μm, and most preferably in the range of 15 μm to 30 μm. When the outer diameter d1 of the discretely distributed concavo-convex portion is smaller than the lower limit value, it becomes difficult to process the shape of the concave portion or convex portion of the concavo-convex portion, so that the obtained shape becomes unstable, resulting in increase in cost. In addition, it becomes difficult to satisfactorily prevent the sticking. On the other hand, when the outer diameter d1 of the discretely distributed concavo-convex portion is larger than the upper limit value, the concavo-convex portion easily becomes visualized as a bright point. That is, when the outer diameter d1 of the concavo-convex portion falls within the above preferable range, the problems described above can be prevented. The diameter d2 of the center portion of the concavo-convex portion is set in the range of, e.g., 10 μm to 20 μm.

The height or depth h of the concavo-convex portion is preferably set in the range of 2 μm to 10 μm, more preferably in the range of 3 μm to 8 μm, and most preferably in the range of 4 μm to 6 μm. When the height or depth h of the discretely distributed concavo-convex portion is smaller than the lower limit value, it becomes difficult to satisfactorily prevent the sticking. On the other hand, when the height or depth h of the concavo-convex portion is larger than the upper limit value, it becomes difficult to process the shape of the concave portion or convex portion of the concavo-convex portion, so that the obtained shape becomes unstable, resulting in increase in cost. In addition, the concavo-convex portion easily becomes visualized as a bright point. That is, when the height or depth h of the concavo-convex portion falls within the above preferable range, the problems described above can be prevented.

The distribution density of the concavo-convex portions in the slightly concavo-convex structure of the light exit surface 42 is preferably set in the range of 5/mm² to 50/mm², more preferably in the range of 10/mm² to 40/mm², and most preferably in the range of 15/mm² to 30/mm². When the distribution density of the concavo-convex portions is smaller than the lower limit value, it becomes difficult to satisfactorily prevent the sticking. On the other hand, when the distribution density of the concavo-convex portions is larger than the upper limit value, it becomes easy to generate speckle. That is, when the distribution density of the concavo-convex portions falls within the above preferable range, the above problems can be prevented.

The distribution of the dot-like concavo-convex portions is preferably a two-dimensionally regular pattern in view of increasing the above-mentioned effects and facilitating an optical design for preventing a factor incurring optical defects. For example, in the case of randomly distributed dots typified by a light diffusion structure formed by coating light-diffusive fine particles, speckle easily occurs due to aggregation of the light-diffusive fine particles. On the other hand, in the case of the regular distribution, speckle hardly occurs since there is no factor described above. Examples of the regular distribution include, e.g., even distribution typified by a grid-like distribution, a fractal distribution, and a structure having a certain level of order (ordered structure). As the ordered structure, the distribution of dots (denoted by black dots) as shown in FIG. 22 can be exemplified.

The surface shapes of the concavo-convex portion can be measured by using a super depth profile measurement microscope, whereby the dimension of the each part of the concavo-convex portion can be obtained.

The above slightly concavo-convex structure of the light exit surface 42 can be formed by chemically etching the light exit surface 42 of the prism sheet or previously applying the chemical etching to a molding member when the molding member is used to transfer and form the light exit surface 42. In this etching, a method disclosed in JP-2004-306554-A can be used. Alternatively, dry etching with the blasting treatment or laser machining can be applied to a molding member so as to form the slightly concavo-convex structure of the light exit surface 42.

In place of or in addition to the formation of the slightly concavo-convex structure on the light exit surface 42 of the prism sheet, the similar slightly concavo-convex structure may be formed on the lower surface of the liquid crystal display element 8 so as to prevent occurrence of the sticking between the light exit surface 42 of the prism sheet 4 and lower surface (surface disposed opposite to the light exit surface 42 of the prism sheet 4) of the liquid crystal element 8. This configuration can also suppress occurrence of optical defects while preventing the sticking without additional use of a light diffusion element such as a light diffusion sheet. In this case, the slightly concavo-convex structure may have an average arithmetic roughness Ra of 0.1 to 0.5 μm and ten-point average roughness of 0.5 to 3.0 μm so as to obtain an antiglare effect.

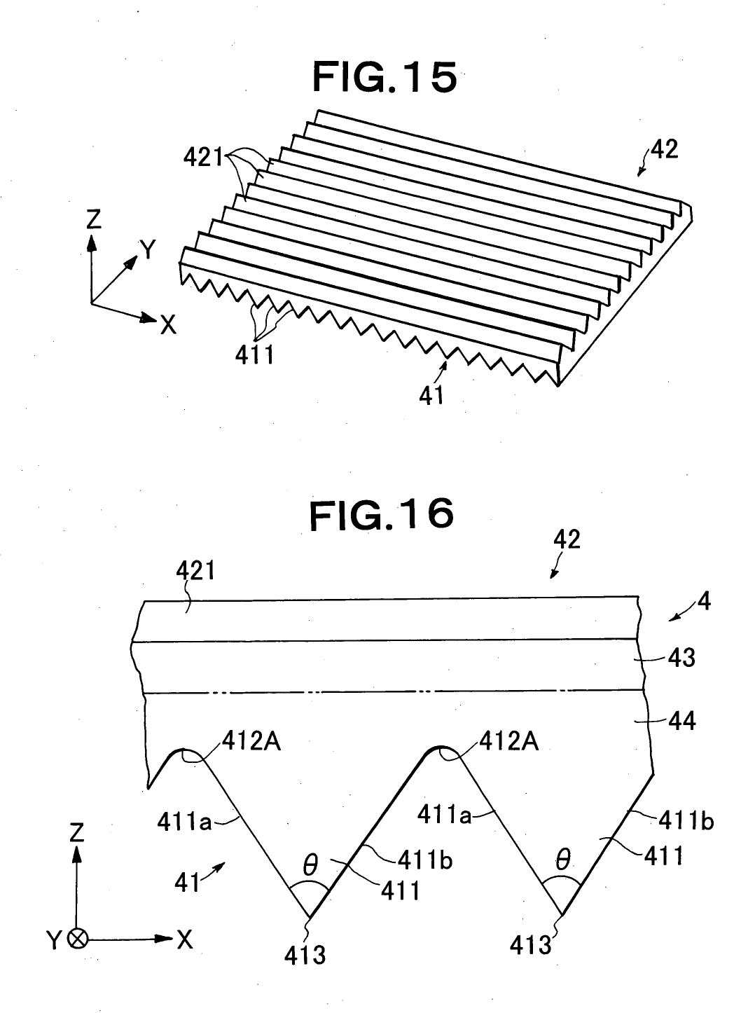

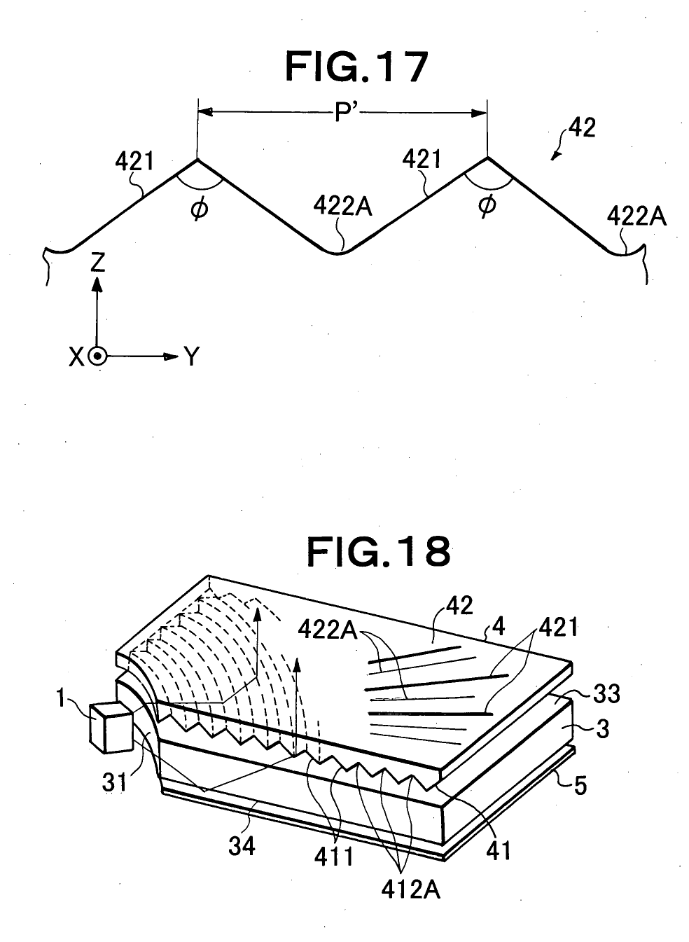

FIG. 15 is a partly enlarged perspective view schematically showing an embodiment of the prism sheet according to the present invention, and FIGS. 16 and 17 are partly enlarged cross-sectional views thereof. In FIGS. 15 to 17, the same reference numerals as those in FIGS. 1 to 14 denote the parts having the same functions as those in FIGS. 1 to 14.

In the present embodiment, the light incident surface 41 is formed as the elongated prism formed surface (first elongated prism formed surface), as well as the light exit surface 42 is formed as the elongated prism formed surface (second elongated prism formed surface). That is, on the light incident surface 41, a plurality of elongated prisms (first elongated prisms) 411 extending in the Y-direction are arranged in parallel to each other. Further, on the light exit surface 42, a plurality of elongated prisms (second elongated prisms) 421 extending in the X-direction perpendicular to the extending direction (Y-direction) of the elongated prisms 411 on the side of the light incident surface 41 are arranged in parallel to each other. Like the elongated prisms formed on the light guide rear surface 34 of the above embodiment as shown in FIG. 1, the elongated prisms 421 on the light exit surface have a function of condensing the emitting light in the YZ plane. This contributes to an increase in the luminance in a desired direction. In order to exhibit such a function, the apex angle φ of the elongated prism 421 shown in FIG. 17 is preferably set in the range of 120 degrees to 160 degrees, and more preferably in the range of 130 degrees to 150 degrees. The elongated prisms 421 on the light exit surface need not be perpendicular to the elongated prisms 411 on the light incident surface and may be formed obliquely (e.g., at an angle within 20 degrees) with respect to the X-direction. In this case, it is possible to obtain a function of condensing the emitting light in the XZ plane. In the case where the function of condensing the emitting light in the YZ plane is not required, the elongated prisms 421 on the light exit surface may be formed in parallel to the elongated prisms 411 on the light incident surface.

As shown in FIG. 16, valley portions (first valley portions) 412A having irregular shapes like those of the above embodiment are formed between the adjacent elongated prisms 411 on the light incident surface. Further, as shown in FIG. 17, valley portions 422A between the adjacent elongated prisms 421 on the light exit surface may be formed into irregular shapes similar to the valley portions 411A between the adjacent elongated prisms on the light incident surface. As a result, it is possible to further enhance a function of concealing the optical defects. The width (dimension in Y-direction) of the valley portion 422A on the light exit surface is preferably set in the range of 0.04 times to 0.5 times the arrangement pitch P′ of the elongated prisms 421, more preferably in the range of 0.08 times to 0.3 times, and most preferably to 0.1 times to 0.2 times.

In the present embodiment, the elongated prisms are formed on the light exit surface side. Thus, when the liquid crystal display element 8 is directly mounted on the light exit surface 42, sticking does not occur.

FIG. 18 is a perspective view schematically showing an embodiment of the surface light source device using the prism sheet according to the present invention. In FIG. 18, the same reference numerals as those in FIGS. 1 to 17 denote the parts having the same functions as those in FIGS. 1 to 17.

In the present embodiment, a dot-like light source such as LED is used as the primary light source 1. One corner of the rectangular light guide 3 is cut off, and the light incident end face 31 is formed at this cut-off portion. The primary light source 1 is disposed so as to face the light incident end face. The light exit mechanism is formed on the light exit face 33 as in the case of the above embodiment.

In the present embodiment, the elongated prism 411 formed on the light incident surface 41 of the prism sheet 4 are arranged in parallel to each other in a concentric manner with the corner of the light guide 3 at which the light incident end face 31 is formed as a center. Such arrangement is included in “substantially parallel arrangement” in the present specification.

In the present embodiment, with respect to a plane parallel to the light exit face 33, the light emitted from the primary light source 1 is divergent light beam. The light introduced into the light guide 3 via the light incident end face 31 substantially radially advances with the primary light source 1 as substantially a center and substantially radially outgoes from the light exit face 33. Since the elongated prisms 411 of the light incident surface of the prism sheet 4 are concentrically arranged as described above, the light introduced into the prism sheet 4 via the light incident surface 41 is, as in the manner described in the above embodiment, deflected in substantially the normal line direction of the light guide light exit face 33 and outgoes from the light exit surface 42. Also in the present embodiment, the valley portion 412A having irregular shapes are formed between the adjacent elongated prisms 411 formed on the light incident surface 41 of the prism sheet 4.

In the present embodiment, the light behavior when viewed with respect to the cross-section (cross-section passing through the primary light source) perpendicular to the extending direction (direction of the tangent lines at respective points of the circular arc) of the elongated prisms 411 is the same as that when viewed with respect to the cross-section (XZ cross-section) perpendicular to the extending direction of the elongated prisms 411 in the above embodiment. Therefore, the dimensional relationship between the elongated prisms 411 and valley portions 412A is the same as that in the above embodiment when viewed with respect to the above cross-sections.

In the present embodiment, a slightly concavo-convex structure as described in the above embodiment may be formed on the light exit surface 42 of the prism sheet 4.

Further, as shown in FIG. 18, the elongated prisms 421 may be formed on the light exit surface 42 of the prism sheet 4. It is preferable that the elongated prisms 421 radially extend with the primary light source 1 as substantially a center. Such arrangement is included in “substantially parallel arrangement” in the present specification. As a result, it is possible to obtain a light condensing effect with respect to the circular arc direction centering on the primary light source 1, thereby contributing to an increase in the luminance in a desired direction.

In the present embodiment, the valley portions between the adjacent elongated prisms 421 on the light exit surface may be formed into irregular shapes similar to those of the valley portions 411A between the adjacent elongated prisms on the light incident surface, as in the case of the above embodiment shown in FIGS. 15 to 17.

### EXAMPLES

The present invention will be described in more detail by using examples.

### Example 1

A shape transfer surface having a shape substantially corresponding to the shape of the elongated prism formed surface shown in FIG. 5A was formed on the surface of a thin plate made of brass (JIS Brass Type 3) having a thickness of 1.0 mm and a size of 400 mm×690 mm. The targeted shape of the elongated prism formed surface was, as shown in FIG. 3, one on which a number of elongated prisms 411 each having an apex angle θ of 65 degrees were arranged at a pitch P of 50 μm. The width W of each of the roughened surface portions 412 was 20 μm. Further, the shape of the second region 412″ of the shape transfer surface of the molding member shown in FIG. 5A was a shape corresponding to one obtained by extending the planar shape of the first region 411a″-411b″.

The shape transfer surface of the molding member was subjected to blasting treatment using blasting particles (glass beads) having average particle diameter of 45 to 75 μm at a nozzle discharge pressure of 0.07 MPa, to thereby form the shape of the second region 412′ as shown in FIG. 5B. The roughening degree of the second region was 0.5 μm in terms of center-line average roughness Ra and 1.5 μm in terms of ten-point average roughness Rz. The roughening degree of the first region was 0.1 μm in terms of center-line average roughness Ra and 0.5 μm in terms of ten-point average roughness Rz. The shape transfer surface thus obtained was coated with an electroless nickel plated layer.

Then, a cylindrical roll made of stainless steel having a diameter of 220 mm and length of 450 mm as shown in FIG. 8 was prepared. The molding member 15 was wrapped around the outer circumferential surface of the cylindrical roll, and fixed thereon with screws to obtain a cylindrical roll mold.

Then, as shown in FIG. 6, a rubber roll 28 made of NBR of rubber hardness of 80 degrees was disposed near the roll mold 7. A polyester film (transparent substrate) 9 having a thickness of 125 μm which was slightly greater in width than the length of the roll mold 7 was fed between the roll mold 7 and rubber roll 28 along the outer surface of the roll mold 7. The polyester film 9 was nipped by the rubber roll 28 and roll mold 7 by means of an air cylinder 11 connected with the rubber roll 28. The operational pressure of the air cylinder 11 was 0.1 MPa. As the air cylinder 11, an air cylinder manufactured by SMC Co. Ltd. having the air tube diameter of 32 mm was used. An ultraviolet light irradiating apparatus 14 was disposed below the roll mold 7. The ultraviolet light irradiating apparatus 14 was of ultraviolet light intensity of 120 W/cm, and constituted by an ultraviolet lamp of 9.6 kW manufactured by Western Quartz Co. Ltd., a parallel ray forming reflector of cold mirror type and an electric power source. An ultraviolet curing composition 10 containing an ingredient for regulating the refractive index, catalyst, etc. was fed into a resin tank 12 having a portion made of stainless steel (SUS 304) only with which the ultraviolet curable composition 10 was in contact. Furthermore, there was provided a warm water jacket for regulating the temperature of the ultraviolet curable composition 10, into which was fed the warm water of the temperature of 40° C. regulated by a temperature regulating apparatus, to thereby maintain the temperature of the ultraviolet curable composition 10 in the resin tank 12 at 40° C.±1° C. In addition, bubbles generated in the composition during the feeding process thereof were removed therefrom by reducing the pressure in the tank 12 with use of vacuum pump.

The ultraviolet curable composition 10 was as follows, and the viscosity thereof was set to 300 mPa·S/25° C.

Phenoxyethylacrylate [Viscoat #192, manufactured by Osaka Organic Chemical Industry Ltd.]: 50 parts by weight

Bisphenol A-diepoxy-acrylate [Epoxy ester 3000A, manufactured by Kyoeisha Co. Ltd.]: 50 parts by weight

2-hydroxy-2-methyl-1-phenyl-propane-1-one [Darocur 1173, manufactured by Nihon Ciba-Geigy K.K.]: 1.5 parts by weight

After the pressure in the resin tank 12 was made normal pressure and the tank was sealed, air pressure of 0.02 MPa was charged into the inside of the resin tank 12, and a valve provided at the lower portion of the resin tank 12 was made open, so that the ultraviolet curable composition 10 was fed between the roll mold 7 and polyester film 9 nipped by the rubber roll 28 and the roll mold 7 via a pipe line and a supply nozzle 13 whose temperature were suitably regulated. As the supply nozzle 13, a valve (AV 101, manufactured by Iwashita Engineering Co. Ltd.) having a needle (MN-18-G13, manufactured by Iwashita Engineering Co. Ltd.) was used. The roll mold 7 was rotated at a circumferential speed of 3.5 m per minute with use of a 0.2 kW geared motor of reduction ratio of 1/200 (manufactured by Mitsubishi Electric Corp.). With the ultraviolet light from the ultraviolet light irradiation apparatus 14 was irradiated the ultraviolet cured composition 10 while being sandwiched between the roll mold 7 and polyester film 9, so that the ultraviolet curable composition 10 was polymerized and cured while transferring an elongated prism pattern of the shape transfer surface of the roll mold 7 onto the polyester film 9. After that, the polyester film 9 was removed from the roll mold 7, whereby a prism sheet was obtained.

The cross-section of the prism sheet thus obtained was observed by a scanning electron microscope (×2000, JSM-840A, manufactured by JEOL Ltd.). The roughened surface portions each had a width of 20 μm and irregular cross-sectional shapes, so that it became clear that the roughened surface portions had a desired structure. An adhesive protecting sheet was secured on the elongated prism formed surface of the prism sheet.

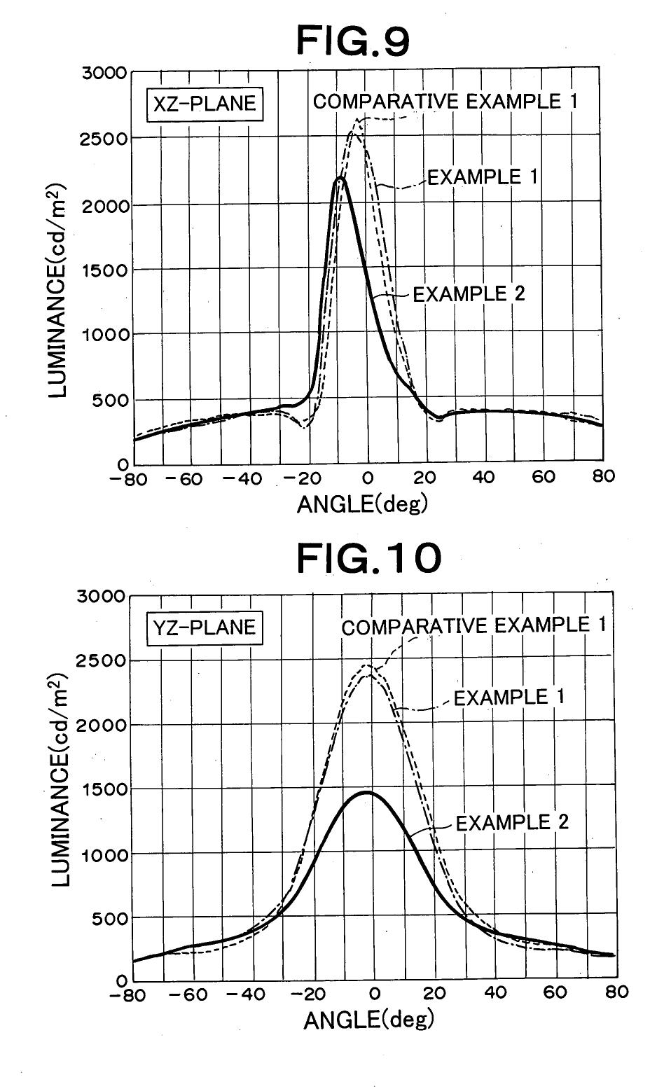

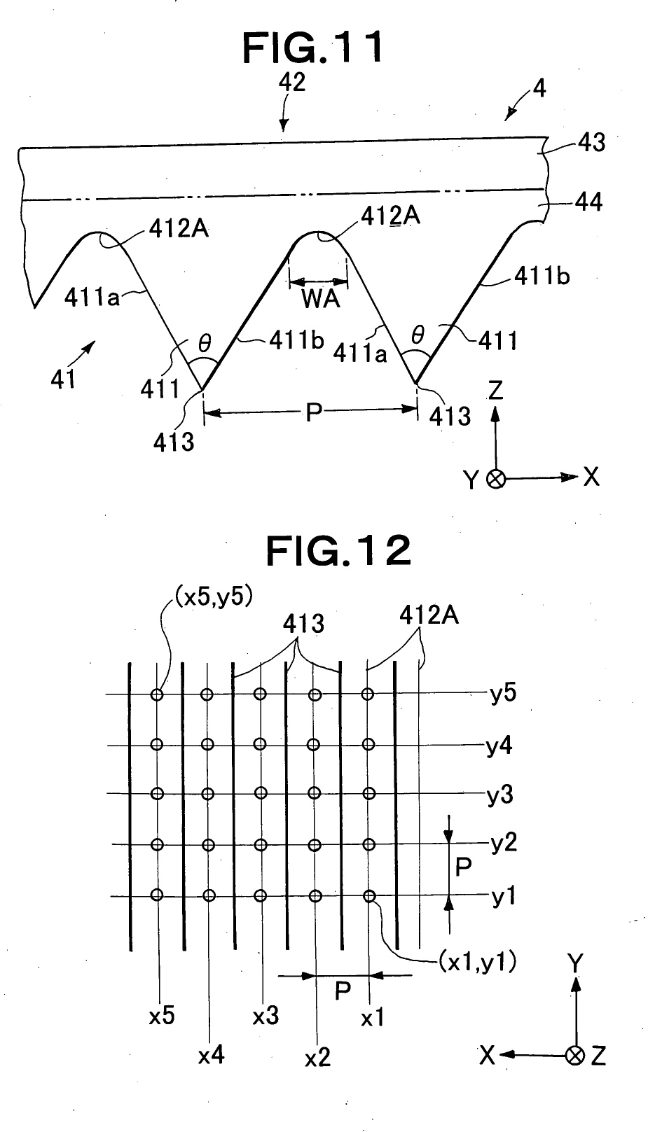

After the adhesive protecting sheet was peeled off, the obtained prism sheet was disposed on the light exit face of the light guide made of acrylic resin, so that the elongated prism formed surface of the prism sheet faces downward as shown in FIGS. 1 and 2. A cold cathode lamp was disposed in the neighborhood of an end face of the light guide. The other end faces and the rear surface of the light guide were covered with reflection sheet, whereby a surface light source device was obtained. The cold cathode lamp was turned on to observe the light emission surface of the surface light source device. As a result, the luminance unevenness was not observed, so that the device was defined as excellent in concealability of optical defects. Further, in the surface light source device, the cold cathode lamp was turned on to measure the luminance distribution (distribution in XZ plane and distribution in YZ plane) of the light emission surface. The result is shown in FIGS. 9 and 10. With regard to the distribution in the XZ plane, the peak luminance value was 2534 cd/m², peak angle was −3.7 degrees, and half-value width was 21 degrees. With regard to the distribution in the YZ plane, the peak luminance value was 2377 cd/m², peak angle was −3.0 degrees, and half-value width was 41 degrees.

### Example 2

A prism sheet was obtained in the same manner as Example 1 except that the nozzle discharge pressure was set to 0.15 MPa in the blasting treatment for the shape transfer surface of the molding member. The roughening degree of the second region after the blasting treatment was 0.8 μm in terms of center-line average roughness Ra and 2.6 μm in terms of ten-point average roughness Rz. The roughening degree of the first region was 0.1 μm in terms of center-line average roughness Ra and 0.5 μm in terms of ten-point average roughness Rz. The roughened surface portions in the obtained prism sheet each had a width of 30 μm and irregular shapes. A surface light source device was obtained in the same manner as Example 1 using the prism sheet. As in the case of Example 1, the cold cathode lamp was turned on to observe the light emission surface of the surface light source device. As a result, the luminance unevenness was not observed, so that the device was defined as excellent in concealability of optical defects. Further, in the surface light source device, the cold cathode lamp was turned on to measure the luminance distribution (distribution in XZ plane and distribution in YZ plane) of the light emission surface. The result is shown in FIGS. 9 and 10. With regard to the distribution in the XZ plane, the peak luminance value was 2207 cd/m², peak angle was −9.1 degrees, and half-value width was 20.5 degrees. With regard to the distribution in the YZ plane, the peak luminance value was 1466 cd/m², peak angle was −4 degrees, and half-value width was 42 degrees.

### Example 3

A prism sheet was obtained in the same manner as Example 1 except that the blasting treatment was conducted as follows. That is, in the blasting treatment for the shape transfer surface of the mold member, a first blasting treatment in which blasting particles (glass beads) having average particle diameter of 45 to 75 μm was sprayed at a nozzle discharge pressure of 0.07 MPa was performed and then a second blasting treatment in which blasting particles (glass beads) having average particle diameter of 10 μm was sprayed at a nozzle discharge pressure of 0.1 MPa was performed. The roughening degree of the second region after the blasting treatment was 0.6 μm in terms of center-line average roughness Ra and 1.7 μm in terms of ten-point average roughness Rz. The roughening degree of the first region was 0.3 μm in terms of center-line average roughness Ra and 0.8 μm in terms of ten-point average roughness Rz. The roughened surface portions in the obtained prism sheet each had a width of 23 Mm and irregular shapes. A surface light source device was obtained in the same manner as Example 1 using the prism sheet. As in the case of Example 1, the cold cathode lamp was turned on to observe the light emission surface of the surface light source device. As a result, the luminance unevenness was not observed, so that the device was defined as excellent in concealability of optical defects.

### Comparative Example 1

A prism sheet was obtained in the same manner as Example 1 except that the blasting treatment for the shape transfer surface of the molding member was not conducted. The center-line average roughness Ra and ten-point average roughness Rz of the elongated prism of the prism sheet thus obtained were 0.16 μm and 0.5 μm at the apex portion of the elongated prism, and 0.05 μm and 0.3 μm at the prism surface. The width of the roughened surface portion was 0 μm, that is, the roughened surface portion did not exist. A surface light source device was obtained in the same manner as Example 1 using the prism sheet. As in the case of Example 1, the cold cathode lamp was turned on to observe the light emission surface of the surface light source device. As a result, luminance unevenness due to poor formation of the prism sheet caused by a defect of a metallic mold for producing the prism sheet or due to residual adhesives of a protecting sheet for the elongated prisms remaining after peeling-off of the protecting sheet from the elongated prisms was observed, so that the device was defined as inferior in concealability of optical defects. Further, in the surface light source device, the cold cathode lamp was turned on to measure the luminance distribution (distribution in XZ plane and distribution in YZ plane) of the light exit face. The result is shown in FIGS. 9 and 10. With regard to the distribution in the XZ plane, the peak luminance value was 2631 cd/m², peak angle was −2.5 degrees, and half-value width was 20 degrees. With regard to the distribution in the YZ plane, the peak luminance value was 2436 cd/m², peak angle was −2 degrees, and half-value width was 40 degrees.

### Example 4

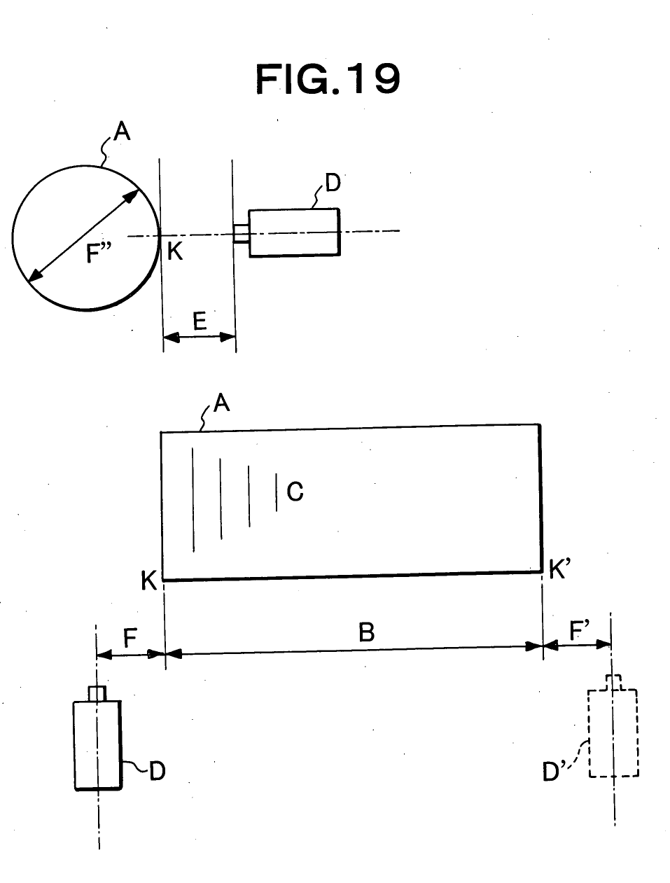

A molding member was produced using an apparatus as shown in FIG. 19.

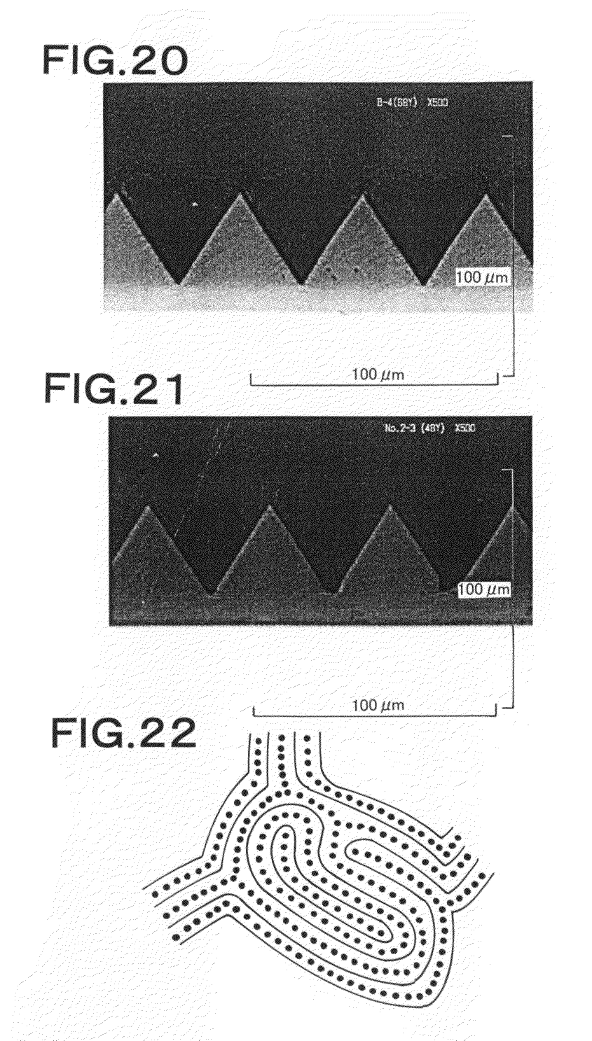

That is, copper plating (not shown) with a thickness of 0.5 mm was applied to the surface of a cylindrical metallic roll having a diameter F″ of 230 mm and length B of 500 mm. Thereafter, the copper-plated surface was smoothened and then subjected to cutting processing by the use of a tool bit to form prism shapes C each having an apex angle of 68 degrees in continuous manner at an arrangement pitch of 50 μm. After that, for the purpose of increasing corrosion resistivity of the molding member, the copper-plated surface was coated with an electroless nickel plated layer (not shown) having the thickness of 1 μm, whereby a molding member blank A on which a plurality of elongated prism shapes were formed in continuous manner was obtained. FIG. 20 is an enlarged photograph of a cross-section of the transfer surface of the elongated prisms and valley portions of the molding member blank A. The shape of the transfer surface including both the elongated prism and valley portion was substantially the same between adjacent repeating units.

The blasting treatment was performed for the molding member blank A as follows. That is, the molding member blank A placed in a blasting box was attached to an apparatus (not shown) that was able to continuously or intermittently rotate the molding member blank A in the circumferential direction. As a blasting machine, air-blast machine AMD-10 manufactured by NICCHU Co., LTD. was used. As a blasting material, glass beads “J-120” manufactured by Potters-Ballotini Co. Ltd. was used. A nozzle D having a tip end diameter of 2 mm was used, the discharge pressure was set to 0.1 MPa, and distance E between the tip end of the nozzle D and surface of the molding member blank A was set to 450 mm. The moving distance of the nozzle D at the time of the blasting treatment was set to 700 mm by adding distance F (100 mm) and distance F′ (100 mm) to an effective area B of the molding member blank A in order to prevent spraying unevenness at the spray start and end times. The blasting treatment was performed while moving the nozzle D up to position D′ at a constant speed of Sm/min in the direction perpendicular to the cutting direction (K-K′ direction) of the elongated prism transfer surface formed on the molding member blank A. Thereafter, the molding member blank A was rotated by a circumferential length of 20 mm (rotated by about 10 degrees) and then the blasting treatment was performed in the same manner in the K-K′ direction. The above operation was repeatedly performed to thereby apply the blasting treatment to the entire circumferential surface of the molding member blank A.

FIG. 21 is an enlarged photograph of a cross-section of the transfer surface of the elongated prisms and valley portions of the molding member thus obtained. All the shapes corresponding to the transfer surfaces of the valley portions (lower end portion in the drawing) were substantially different between adjacent repeating units.

A prism sheet was obtained in the same manner as Example 1 using the molding member thus obtained.

In this case, chemical etching was previously applied to a molding member for transfer in forming one surface of the transparent substrate of the prism sheet, whereby a slightly concavo-convex structure having the following shape and dimension was obtained.

Arithmetic average roughness Ra: 0.021 μm

Roughness curve maximum valley depth Ry: 0.233 μm

Roughness curve ten-point average roughness Rz: 0.214 μm

Roughness curve element average length Sm: 84.375 μm

Roughness curved surface arithmetic average slant RΔa: 0.396 degrees

Outer diameter d1 of concavo-convex portion: 16 μm

Height h of concavo-convex portion: 6 μm

Distribution density of concavo-convex portions: 17/mm² (Measurement Condition)

Measurement length: 5 mm

Slant correction: linear-correction least-squares approach

Cut-off wavelength: 0.25 mm

Twelve-point average

A surface light source device was obtained in the same manner as Example 1 using the obtained prism sheet. The cold cathode lamp was turned on to observe the light emission surface of the surface light source device. As a result, the surface structures of the light guide and prism sheet were not observed and, further, the luminance unevenness was not observed, so that the device was defined as excellent in concealability of optical defects.

Further, a liquid crystal display element was directly mounted on the light emission surface of the prism sheet of the surface light source device to constitute a liquid crystal display device. In this device, sticking between the light exit surface of the prism sheet and liquid crystal display element did not occur.

What is claimed is:

1. A prism sheet comprising:
an elongated prism formed surface having a plurality of elongated prisms extending in parallel to each other; and
a roughened surface portion extending between adjacent elongated prisms along the elongated prisms,
wherein the roughened surface portion has a larger roughening degree than that of the surface of each elongated prism.

2. The prism sheet according to claim 1, wherein the roughened surface portion has a width 0.04 to 0.5 times the arrangement pitch of the elongated prisms.

3. A method for producing the prism sheet according to claim 1, comprising:
producing a molding member having a shape transfer surface including a first region having a shape corresponding to or substantially corresponding to the elongated prisms and a second region having a shape substantially corresponding to the roughened surface portion;
applying blasting treatment to the shape transfer surface of the molding member to roughen the second region and make the shape of the second region corresponding to the roughened surface portion; and
forming the elongated prisms on the surface of a synthetic resin sheet using the molding member.

4. The method for producing the prism sheet according to claim 3, wherein the blasting treatment is performed by spraying blasting particles having an average particle diameter 0.3 to 5 times the arrangement pitch of the elongated prisms.

5. The method for producing the prism sheet according to claim 3, wherein the blasting treatment is performed by spraying blasting particles having an average particle diameter 0.3 to 5 times the arrangement pitch of the elongated prisms, and further spraying blasting particles having an average particle diameter 0.1 to 0.5 times the arrangement pitch of the elongated prisms.

6. A surface light source device comprising:
a primary light source;
a light guide into which light emitted from the primary light source is introduced, by which the introduced light is guided, and from which the guided light is emitted; and
the prism sheet according to claim 1 so disposed as to receive the light emitted from the light guide,
wherein the light guide includes a light incident end face on which the light emitted from the primary light source is incident and a light exit face from which the guided light is emitted, the primary light source is arranged adjacent to the light incident end face of the light guide, and the prism sheet is arranged such that the elongated prism formed surface faces the light exit face of the light guide.

7. A prism sheet comprising:
an elongated prism formed surface having a plurality of elongated prisms extending in parallel to each other; and
a valley portion extending between adjacent elongated prisms along the elongated prisms,
wherein the valley portion has an irregular cross-sectional shape.

8. The prism sheet according to claim 7, wherein the other surface of the prism sheet on the opposite side to the surface which is the elongated prism formed surface has a concavo-convex structure having an average slant angle of 0.2 to 3 degrees.

9. The prism sheet according to claim 7, wherein the other surface of the prism sheet on the opposite side to the surface which is the elongated prism formed surface has a concavo-convex structure having an arithmetic average roughness Ra of 0.01 μm to 0.05 μm.

10. The prism sheet according to claim 7, wherein the other surface of the prism sheet on the opposite side to the surface which is the elongated prism formed surface has a concavo-convex structure having a roughness curve maximum valley depth Ry of 0.1 μm to 0.5 μm.

11. The prism sheet according to claim 7, wherein the other surface of the prism sheet on the opposite side to the surface which is the elongated prism formed surface has a concavo-convex structure having a roughness curve ten-point average roughness Rz of 0.1 μm to 0.5 μm.

12. The prism sheet according to claim 7, wherein the other surface of the prism sheet on the opposite side to the surface which is the elongated prism formed surface has a concavo-convex structure having a roughness curve element average length Sm of 50 μm to 900 μm.

13. The prism sheet according to claim 7, wherein the other surface of the prism sheet on the opposite side to the surface which is the elongated prism formed surface has a concavo-convex structure having a roughness curved surface arithmetic average slant RΔa of 0.1 degrees to 1 degree.

14. The prism sheet according to claim 7, wherein the other surface of the prism sheet on the opposite side to the surface which is the elongated prism formed surface has a concavo-convex structure constituted by concavo-convex portions discretely distributed.

15. The prism sheet according to claim 14, wherein each concavo-convex portion has an outer diameter of 10 μm to 60 μm.

16. The prism sheet according to claim 14, wherein each concavo-convex portion has a height or depth of 2 μm to 10 μm.

17. The prism sheet according to claim 14, wherein the concavo-convex portions have a distribution density of 5/mm² to 50/mm².

18. A prism sheet comprising:
a first elongated prism formed surface having a plurality of first elongated prisms extending in parallel to each other;
a second elongated prism formed surface having a plurality of second elongated prisms extending in parallel to each other; and
a first valley portion extending between adjacent first elongated prisms along the first elongated prisms,
wherein the first valley portion has an irregular cross-sectional shape.

19. The prism sheet according to claim 18, further comprising a second valley portion extending between adjacent second elongated prisms along the second elongated prisms, wherein the second valley portion has an irregular cross-sectional shape.

20. The prism sheet according to claim 18, the second elongated prisms extend perpendicular to the first elongated prisms.

21. The prism sheet according to claim 7, the elongated prisms or at least one of the first and second elongated prisms are concentrically arranged.

22. The prism sheet according to claim 18, the elongated prisms or at least one of the first and second elongated prisms are concentrically arranged.

23. A surface light source device comprising:
a primary light source;
a light guide into which light emitted from the primary light source is introduced, by which the introduced light is guided, and from which the guided light is emitted; and
the prism sheet according to claim 7 so disposed as to receive the light emitted from the light guide,
wherein the light guide includes a light incident end face on which the light emitted from the primary light source is incident and a light exit face from which the guided light is emitted, the primary light source is arranged adjacent to the light incident end face of the light guide, and the prism sheet is arranged such that the elongated prism formed surface or the first or second elongated prism formed surface faces the light exit face of the light guide.

24. A surface light source device comprising:
a primary light source;
a light guide into which light emitted from the primary light source is introduced, by which the introduced light is guided, and from which the guided light is emitted; and
the prism sheet according to claim 18 so disposed as to receive the light emitted from the light guide,
wherein the light guide includes a light incident end face on which the light emitted from the primary light source is incident and a light exit face from which the guided light is emitted, the primary light source is arranged adjacent to the light incident end face of the light guide, and the prism sheet is arranged such that the elongated prism formed surface or the first or second elongated prism formed surface faces the light exit face of the light guide.

25. A liquid crystal display device comprising:
the surface light source device according to claim 23; and
a liquid crystal display element,
wherein the surface light source device includes the prism sheet according to claim 8, the surface of the prism sheet on the side opposite to the surface facing the light exit face of the light guide has the concavo-convex structure or formed as the second or first elongated prism formed surface, and the liquid crystal display element is directly mounted on the surface of the prism sheet of the surface light source device on the opposite side to the surface facing the light exit face of the light guide.

26. A liquid crystal display device comprising:
the surface light source device according to claim 24; and
a liquid crystal display element,
wherein the surface of the prism sheet on the side opposite to the surface facing the light exit face of the light guide has the concavo-convex structure or formed as the second or first elongated prism formed surface, and the liquid crystal display element is directly mounted on the surface of the prism sheet of the surface light source device on the opposite side to the surface facing the light exit face of the light guide.

27. The liquid crystal display device according to claim 25, wherein a concavo-convex structure is formed on the surface of the liquid crystal display element that faces the prism sheet.

28. The liquid crystal display device according to claim 27, wherein the concavo-convex structure of the liquid crystal display element has the same structure as the concavo-convex structure of the prism sheet.

29. A method for producing the prism sheet according to claim 7, comprising:
producing a molding member having a shape transfer surface including a first region having a shape corresponding to or substantially corresponding to the elongated prisms or the first or second elongated prisms and a second region having a shape substantially corresponding to the valley portion or the first or second valley portion;
applying blasting treatment to the shape transfer surface of the molding member to make the shape of the second region corresponding to the valley portion or the first or second valley portion; and
forming the elongated prisms or the first or second elongated prisms on the surface of a synthetic resin sheet using the molding member.

30. The method for producing the prism sheet according to claim 29, wherein the blasting treatment is performed by spraying blasting particles having an average particle diameter 0.3 to 5 times the arrangement pitch of the elongated prisms or the first or second elongated prisms.

31. The method for producing the prism sheet according to claim 29, wherein the blasting treatment is performed by spraying blasting particles having an average particle diameter 0.3 to 5 times the arrangement pitch of the elongated prisms or the first or second elongated prisms, and further spraying blasting particles having an average particle diameter 0.1 to 0.5 times the arrangement pitch of the elongated prisms or the first or second elongated prisms.

32. A method for producing the prism sheet according to claim 18, comprising:
producing a molding member having a shape transfer surface including a first region having a shape corresponding to or substantially corresponding to the elongated prisms or the first or second elongated prisms and a second region having a shape substantially corresponding to the valley portion or the first or second valley portion;
applying blasting treatment to the shape transfer surface of the molding member to make the shape of the second region corresponding to the valley portion or the first or second valley portion; and
forming the elongated prisms or the first or second elongated prisms on the surface of a synthetic resin sheet using the molding member.

33. The method for producing the prism sheet according to claim 32, wherein the blasting treatment is performed by spraying blasting particles having an average particle diameter 0.3 to 5 times the arrangement pitch of the elongated prisms or the first or second elongated prisms.

34. The method for producing the prism sheet according to claim 32, wherein the blasting treatment is performed by spraying blasting particles having an average particle diameter 0.3 to 5 times the arrangement pitch of the elongated prisms or the first or second elongated prisms, and further spraying blasting particles having an average particle diameter 0.1 to 0.5 times the arrangement pitch of the elongated prisms or the first or second elongated prisms.
